(19) United States
(12) Patent Application Publication
(10) Pub. No.: US 2025/0214226 A1
(43) Pub. Date: Jul. 3, 2025

(54) LIGHTWEIGHT HIGH TORQUE EXOSKELETON

(71) Applicant: San Jose State University Research Foundation, San Jose, CA (US)

(72) Inventor: Mojtaba Sharifi, San Jose, CA (US)

(73) Assignee: San Jose State University Research Foundation, San Jose, CA (US)

(21) Appl. No.: 18/759,802

(22) Filed: Jun. 28, 2024

Related U.S. Application Data
(60) Provisional application No. 63/595,222, filed on Nov. 1, 2023.

(51) Int. Cl. B25J 9/00; A61H 3/00

(52) U.S. Cl. CPC B25J 9/0006; A61H 3/00; A61H 2003/007

(57) ABSTRACT

A wearable exoskeleton comprising: a base; an articulable mechanical member configured to be secured to a portion of the human anatomy having a joint; a pulley motor secured to the base; a Bowden cable secured to the pulley motor and the articulable mechanical member; wherein the mechanical member is configured to articulate in response to the pulley motor imparting force to the Bowden cable.

### CROSS-REFERENCE TO RELATED APPLICATION

This patent application claims the benefit of U.S. Provisional Patent Application No. 63/595,222, filed Nov. 1, 2023, entitled “LIGHTWEIGHT, HIGH-TORQUE, AND COST-EFFECTIVE HIP EXOSKELETON”, which is incorporated by reference herein in its entirety.

### BRIEF DESCRIPTION OF ALL OF THE DRAWINGS

This BRIEF DESCRIPTION OF ALL OF THE DRAWINGS lists all of the drawings in this patent application. Portions of the list of drawings are reproduced throughout the application as explained in the TABLE OF CONTENTS, which is set forth below.

FIG. 1 is a frontal left-side downward-looking perspective view of a hip exoskeleton mounted to a mannequin in accordance with an example embodiment.

FIG. 2 is a back right-side upward-looking perspective view of a hip exoskeleton mounted to a mannequin in accordance with an example embodiment.

FIG. 3 is an illustrative perspective view showing the left-side motor support panel in accordance with some embodiments.

FIG. 4 is an illustrative front view of the left-side motor support panel in accordance with some embodiments.

FIG. 5 is an illustrative top view of the left-side motor support panel in accordance with some embodiments.

FIG. 6 is a perspective view of a hip connector of the type connected to outer surfaces of the right-side motor support panel the left-side motor support panel.

FIG. 7 is an upward looking perspective exploded view of a left-side elongated rod, a left-side hip motor coupler, and a left-side thigh brace in accordance with some embodiments.

FIG. 8 is a downward looking perspective assembled view of the left-side elongated rod, the left-side hip motor coupler, and the left-side thigh brace in accordance with some embodiments.

FIG. 9 is an illustrative chart showing estimated torque required for hip joint movement of a user 1 and user 2.

FIG. 10 is an illustrative drawing showing FEA results for example long hip components.

FIG. 11 is an illustrative drawing showing FEA results for an example hip connector part.

FIG. 12 is an illustrative drawing showing FEA results of the large trunk support component.

FIG. 13 is and illustrative drawing showing an experimental setup to test a control and actuation system including for a hip exoskeleton in accordance with some embodiments.

FIG. 14 is an illustrative drawing showing an example architecture of mechatronic hardware and software for the hip exoskeleton.

FIGS. 15A-15D are illustrative drawings showing components of the hip exoskeleton.

FIG. 15A is a front view of a fully assembled hip exoskeleton. FIG. 15B is a front view of a fully assembled hip exoskeleton mounted to a user.

FIG. 15C is a right-side view of a fully assembled hip exoskeleton mounted to a user.

FIG. 15D is a back view of a fully assembled hip exoskeleton mounted to a user.

FIG. 16A is a back view design hip exoskeleton device with motors on each side and leg brace connecting to the thigh.

FIG. 16B is a fabricated side view hip exoskeleton device with motors on each side and leg brace connecting to the thigh.

FIG. 17A is a front view design mechatronic storage device for the mini-pc, battery, and intermediary boards.

FIG. 17B is a fabricated (b) mechatronic storage device for the mini-pc, battery, and intermediary boards.

FIG. 18 is a mechatronics system including the mini-pc, motors, and intermediary boards to run our components for controlling and testing the AK80-64 motors.

FIG. 19 is a mechatronics communication between the Mini-PC and motors for the hip exoskeleton: C++ code is uploaded on the microcontroller for CAN communication with motors and data is received back using a FT232RL serial converter.

FIG. 20A is a front view hip exoskeleton testing device with motors on each side and leg brace connecting to the thigh.

FIG. 20B is a Side view-hip exoskeleton testing device with motors on each side and leg brace connecting to the thigh.

FIG. 20C is a Back view hip exoskeleton testing device with motors on each side and leg brace connecting to the thigh.

FIG. 21 is a tracking a typical hip trajectory using Kp=100 in a typical walking with the frequency of 1.8 rad/sec.

FIG. 22 is a delivered motor torque during walking with the speed of 1.8 rad/sec with Kp=100.

FIG. 23 is a tracking a typical hip trajectory using Kp=300 in a typical walking with the frequency of 1.8 rad/sec.

FIG. 24 is a delivered motor torque during walking with the speed of 1.8 rad/sec with Kp=300.

FIG. 25 is a delivered motor torque during walking with the speed of 2.5 rad/sec with Kp=300.

FIG. 26 is a delivered motor torque during walking with the speed of 2.5 rad/sec with Kp=300.

FIG. 27A is a sitting procedure when the human user has the hip exoskeleton testing device attached to their limbs.

FIG. 27B is a standing procedure when the human user has the hip exoskeleton testing device attached to their limbs.

FIG. 28 is a sit-to-stand trajectory tracking for a 6 sec period.

FIG. 29 is a sit-to-stand trajectory tracking for a 3 sec period.

FIG. 30 is an applied motor torque for sit-to-stand motion within two time Periods (6 sec and 3 sec).

FIG. 31 is an illustrative drawing showing a perspective view of a knee exoskeleton in accordance with some embodiments.

FIG. 32A is an illustrative drawing showing the example knee exoskeleton of FIG. 31 mounted to a user's leg with the knee chain fully compressed.

FIG. 32B is an illustrative drawing showing the example knee exoskeleton of FIG. 31 mounted to a user's leg with the knee chain partially compressed.

FIG. 32C is an illustrative drawing showing the example knee exoskeleton of FIG. 31 mounted to a user's leg with the knee chain fully extended.

FIG. 33 is an illustrative drawing showing an example knee exoskeleton and hip exoskeleton mounted to a user.

FIG. 34 is an illustrative drawing showing a side view of an example five-link knee chain in a fully compressed state of curvature.

FIG. 35 is an illustrative drawing showing perspective view of another example five-link knee chain in a fully extended state of curvature.

FIG. 36 is an illustrative drawing showing a perspective view of an example six-link knee chain in a fully compressed state of curvature.

FIG. 37 is an illustrative drawing showing perspective view of the example six-link knee chain of FIG. 36 in a fully extended state of curvature.

FIG. 38 is an example side perspective view of an inner link of a knee chain in accordance with some embodiments of FIGS. 34, 36, 37.

FIG. 39 is an example bottom perspective view of end link of a knee chain in accordance with some embodiments of FIGS. 33, 35, 36.

FIG. 40 is an example bottom view of end link of a knee chain in accordance with some embodiments of FIGS. 33, 35, 36.

FIG. 41 is an illustrative drawing showing two pulley motors mounted to a base support structure that can be worn upon a user's back.

FIG. 42 is an illustrative drawing showing an example individual links of the example five-link geometry of the knee chain of FIG. 35.

FIG. 43 is an illustrative fabrication of the six-link knee chain design, total length of 15 in and bend angle of 30 degrees

FIG. 44A is an illustrative drawing showing results of an FEA study that showed a maximum displacement of 0.01 mm for the Semi-Rigid Knee Chain Links under the maximum 800 N load.

FIG. 44B is an illustrative drawing showing results of an FEA study that showed a maximum stress of 20 MPa (b) for the Semi-Rigid Knee Chain Links under the maximum 800 N load.

FIG. 44C is an illustrative drawing showing a fatigue analysis that shows that the Knee Chain can withstand 1.5×106 cycles (c).

FIG. 45 shows graphs showing experimental results of the slow walk test (ω=1.4 rad/s): The maximum torque observed was 12 Nm.

FIG. 46 shows graphs showing experimental results of the fast walk test (ω=2.8 rad/s). Maximum torque observed was 29 Nm.

FIG. 47 is an illustrative drawing showing a perspective view of an ankle-foot exoskeleton in accordance with some embodiments.

FIG. 48 is an illustrative drawing showing the example ankle-foot exoskeleton of FIG. 47 mounted to a user. The user is wearing a shoe.

FIG. 49 is an illustrative perspective view of the example foot holder section of FIG. 47.

FIG. 50 is a top elevation view of the example foot holder section of FIG. 47.

FIG. 51 is an illustrative perspective view of the example lower leg holder section of FIG. 47.

FIG. 52 is a top elevation view of the example lower leg holder section of FIG. 47.

FIG. 53 is an illustrative drawing of a lower leg holder section fabricated part and a corresponding stress-strain analysis for the fabricated part.

FIG. 54 is an illustrative drawing of a foot holder section fabricated part and a stress-strain analysis for the fabricated part.

FIG. 55 is an illustrative drawing of a model in CAD software of a pressure insole casting mold.

FIG. 56 is an illustrative drawing of a model in CAD software of a sensor caps casting model.

FIG. 57 is an illustrative drawing of a completed rubber insole with embedded pressure sensors.

FIG. 58 is an illustrative drawing that shows an example configuration of a pressure insole sensor system.

FIG. 59 is an illustrative curve showing force/resistance correlation up to 50 lbs as measured on the example pressure sensor system.

FIG. 60 shows illustrative graphs indicating force-sensitive resistor pressure readings during standing test trial for 180 and 200 lb test subjects.

FIG. 61 shows illustrative graphs indicating gait cycle with labeled stance phase of the foot during a walking motion.

FIG. 62 shows illustrative graphs indicating ankle trajectory for walking motion at frequency rates of 1, 2, and 3 radians/second.

FIG. 63 is an illustrative perspective view of an example upper limb exoskeleton for shoulder and elbow in accordance with some embodiments.

FIG. 64 an illustrative perspective view of the example upper limb exoskeleton of FIG. 1 with the gimbal assembly configured in an example second static gimbal position.

FIG. 65 an illustrative perspective view of the example upper limb exoskeleton of FIG. 1 with the gimbal assembly configured in an example third static gimbal position.

FIG. 66 an illustrative perspective view of the example upper limb exoskeleton of FIG. 1 with the static gimbal assembly configured in an example fourth gimbal position.

FIG. 67 is an illustrative perspective drawing showing certain details of a first pulley. In accordance with some embodiments.

FIG. 68 is an illustrative perspective drawing showing certain details of a first motor mounted to the base support structure in accordance with some embodiments.

FIG. 69A is an illustrative drawing showing a CAD model perspective view of an example telescopable adjustable length upper arm section CAD model.

FIG. 69B is an illustrative drawing showing a CAD model perspective view of an example telescopable adjustable length forearm section CAD model.

FIG. 70A is an illustrative drawing showing an example upper arm cuff and corresponding cuff adapter.

FIG. 70B is an illustrative drawing showing an example forearm cuff and corresponding cuff adapter.

FIG. 71 is an illustrative drawing showing a gyro-accelerometer unit secured to a user's arm and showing exploded views of the unit.

FIG. 72 is an illustrative drawing showing gyroscope and accelerometer readings from the gyro-accelerometer unit of FIG. 71.

FIG. 73 is an illustrative drawings representing an example ESP setup for CAN module and backplate MPU.

### TABLE OF CONTENTS

A. HIP EXOSKELETON
A1. BACKGROUND/Hip Exoskeleton
   [0002]-[0007]
A2. BRIEF DESCRIPTION OF THE DRAWINGS/HIP Exoskeleton
   [0008]-[0026]
A3. DETAILED DESCRIPTION/Hip Exoskeleton
   [0027]-[0098]
A4. REFERENCES/Hip Exoskeleton
   [0099]-[0127]
B. HIP EXOSKELETON MECHATRONICS
B1. BRIEF DESCRIPTION OF THE DRAWINGS/Hip Exoskeleton Mechatronics
   [0129]-[0144]
B2. DETAILED DESCRIPTION/Hip Exoskeleton Mechatronics
   [0145]-[0156]
B3. REFEREENCES/Hip Exoskeleton Mechatronics
   [0157]-[0193]
C. KNEE EXOSKELETON
C1. BACKGROUND/Knee Exoskeleton
   [0195]-[0202]
C2. BRIEF DESCRIPTION OF THE DRAWINGS/Knee Exoskeleton
   [0203]-[0221]
C3. DETAILED DESCRIPTION/Knee Exoskeleton
   [0222]-[0268]
C4. REFERENCES/Knee Exoskeleton
   [0269]-[0291]
D. ANKLE-FOOT EXOSKELETON
D1. BACKGROUND/Ankle-Foot Exoskeleton
   [0293]-[0299]
D2. BRIEF DESCRIPTION OF THE DRAWINGS/Ankle-Foot Exoskeleton
   [0300]-[0316]
D3. DETAILED DESCRIPTION/Ankle-Foot Exoskeleton
   [0317]-[0344]
D4. REFERENCES/Ankle-Foot Exoskeleton
   [0345]-[0372]
E. UPPER LIMB EXOSKELETON FOR SHOULDER AND ELBOW
E1. BACKGROUND/Upper Limb, Shoulder, Elbow
   [0374]-[0377]
E2. BRIEF DESCRIPTION OF THE DRAWINGS/Upper Limb, Shoulder, Elbow
   [0378]-[0391]
E3. DETAILED DESCRIPTION/Upper Limb, Shoulder, Elbow
   [0392]-[0420]
E4. REFERENCES/Upper Limb, Shoulder, Elbow

### A. Hip Exoskeleton

### A1. BACKGROUND/Hip Exoskeleton

Over 600,000 people in America are suffering from disabilities related to spinal cord injury (SCI), and multiple sclerosis (MS) combined [1], [2]. According to the National Institute of Neurological Disorders and Stroke (NINDS), both SCI and MS can result in neurological conditions and physical impairments [3]. The National SCI Database (NSCID) analyzed the causes of SCIs from 2005 to 2011 and found that automobile accidents (31.5%), falling (25.3%), shootings (10.4%), and motorcycle accidents (6.8%) were the leading causes [4]. Elderly individuals who suffer from chronic illnesses and motor disabilities face difficulties in carrying out activities of daily living (ADLs) and moving around due to their declining locomotive functions [5]. To address this issue, wearable robotic systems and exoskeletons have been developed to assist and rehabilitate these individuals, thereby reducing their secondary complications.

Powered exoskeletons can provide consistent, long-term physical assistance with minimal involvement from a caregiver or therapist [6]. An affordable lower limb exoskeleton has the potential to reduce healthcare costs, free up social labor, and provide timely support for activities of daily living such as walking. Additionally, sensors embedded in the exoskeleton structure can collect precise measurements of human limb movements, allowing for continuous monitoring of the user's condition. Some examples of commercially available lower-limb exoskeletons include EksoNR, ReWalk Personal 6.0, Hybrid Assistive Limb (HAL), and Indego [7]-[9]. All of the exoskeletons mentioned belong to the category of wearable exoskeletons designed to assist individuals with severe lower limb disabilities in performing activities of daily living [10], [11]. These exoskeletons are equipped with new technology in actuation systems, and power sources for precise smooth controls. Durable textiles and refined components used in these devices make them lighter, more flexible, and more comfortable.

The EksoNR exoskeleton, created by Esko Bionics in Richmond, CA, consists mostly of rigid metal components. The trunk, hip, knee, and ankle parts are connected by tubular metal connectors which transmit power from the actuator. Due to its heavy weight of about 27 kg, the exoskeleton may be difficult to maneuver [12]. HAL is made by the Japanese manufacturer Cyberdyne and the components are made from special sturdy plastic and use motors and gears to actuate the movements and battery to the power system [13], [14]. It has similar rigid components as in EksoNR but uses special sturdy plastics for most components and they were able to reduce the weight by almost half of Ekso, approximately 14 kg [13]. ReWalk Personal 6.0 exoskeleton frame is made from Aluminium alloy, and plastic and uses motors and gear to actuate the movements and battery to the power system. It weighs 23.3 kg which also falls on the heavier side of the spectrum [9], [15]. Similarly, Indego follows the rigid construction and weighs approximately 13 kg which is the lightest exoskeleton among all the exoskeletons mentioned in this literature review, and it is one of the best options in this exoskeleton category that are currently available in the market [16]. As in most conventional exoskeletons, all four exoskeletons have similar rigid construction and share a common design approach to most of the components on the exoskeleton [12], [15]. Even though these exoskeletons are the leading exoskeletons currently available in the market, it is still very heavy, bulky and each cost around $100,000 and offers very limited flexibility in the transverse and frontal plane [12], [13], [15], [16]. The cost of the exoskeleton makes the exoskeleton unaffordable to most patients. Also, the heavy weight and bulkiness of the exoskeletons make them impractical for the public for regular use.

In an exoskeleton, the movement of the leg is mostly supported by the hip part so it must provide enough torque, approximately 40 Nm [17], [18], to replicate the hip movement and at the same time keep its weight as light as possible. Lee et al. developed a flexible hip exoskeleton called Gait Enhancing Mechatronics System (GEMS) which offers better flexibility and a slim and lightweight design of the hip exoskeleton that weighs approximately 2.6 Kg which is one-tenth of the weight of the EKsoNR [17]. The GEMS consists of flexible sliding thigh frames, a flexible hip brace, actuators, and wearable fabrics which allow it to keep its slim designs, and lightweight, and permit better movements in frontal and transverse planes. The actuators were placed in the flexible hip brace and provided a maximum torque of 12 Nm to assist the leg movement. GEMS has a flexible sliding thigh frame that curves from the side of the body to the front of the knee and incorporates soft thigh fasteners that provide a better experience to the user while putting it on and off [17]. Similarly, at Samsung Electronics (Suwon, Korea), the hip exoskeleton was developed by Seo et al. GEMSv2 (gait enhancing mechatronics system v2) was an upgraded version of the GEMS and weighs 2.4 kg and the battery could support the system for up to 2 hours. The components were made up of carbon-reinforced plastic resins and the battery that powers the system was placed at the front of the exoskeleton to distribute the weight evenly. It uses the same actuator as the GEMS and provides a maximum torque of 12 Nm [19]. It is one of the lightest, most aesthetically pleasing, flexible, and most comfortable hip exoskeletons that was developed but the cost of it was unclear and might be too expensive for the general population. Additionally, both GEMS and GEMSv2 had some limitation since the torque generated by both hip exoskeletons were enough to assist the hip movement, but it was not enough to fully support/control the hip movement without the user's input.

Zhang et al. developed a hip exoskeleton with 4-DOF which offered better control of the frontal and sagittal planes as compared to the other hip exoskeletons that are reviewed in this literature [20]. The Maxon motor used in the exoskeleton to actuate the hip generated torque of 40 Nm which was enough to fully control the hip exoskeleton without the user's input. However, it weighed 9.2 kg without the battery unit which is almost four times heavier than GEMSv2. The incorporation of the series elastic actuator (SEA) in the system did help reduce some of the weight of the exoskeleton and offered better control of the movement but it still needs improvements. In contrast to all three motor-actuated hip exoskeletons mentioned above, Yang et al. developed a 3-DOF hip exoskeleton using hydraulic servo rotary actuators which could provide a maximum torque of up to 120 Nm [18]. Even though the hydraulic servo rotary actuator provides torque almost 10 times higher than GEMSv2, the generated torque was way over the required torque which is approximately 40 Nm for full control of the hip [18], [21]. Additionally, Maxon motors used by Zhang et al. on the hip exoskeleton with built-in gear ratio systems are readily available in the market that could generate the required torque and keep the cost and weight relatively low.

Although these exoskeletons are now being used in some clinical settings, their heaviness, costs, and safety considerations have made them less practical for home-based and long-term assistance and rehabilitation. In this study, a lightweight, high torque, and cost-effective hip exoskeleton is designed and fabricated for assistance, rehabilitation, and gait training applications.

### A2. BRIEF DESCRIPTION OF THE DRAWINGS/Hip Exoskeleton

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

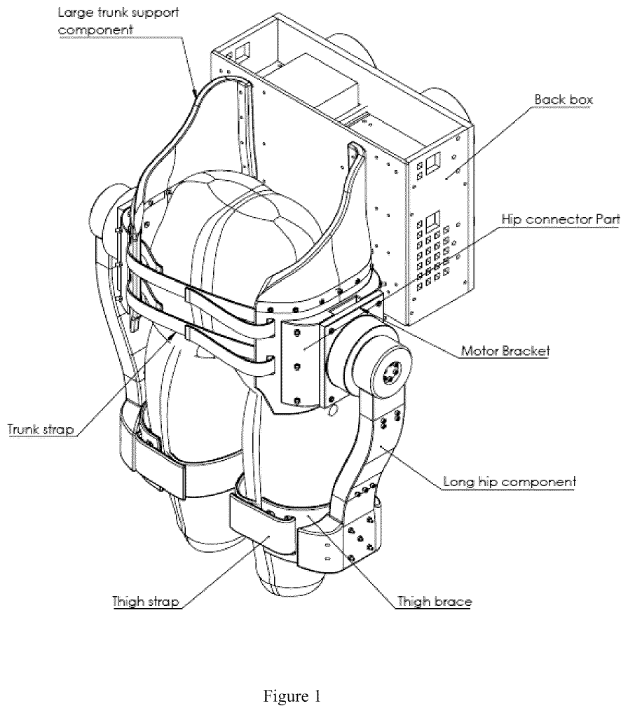

FIG. 1 is a frontal left-side downward-looking perspective view of a hip exoskeleton mounted to a mannequin in accordance with an example embodiment.

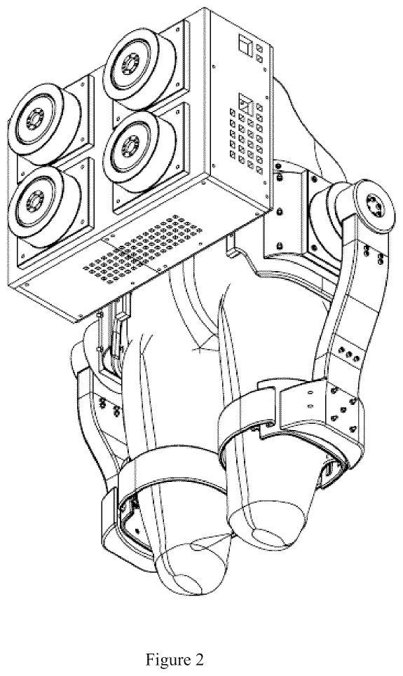

FIG. 2 is a back right-side upward-looking perspective view of a hip exoskeleton mounted to a mannequin in accordance with an example embodiment.

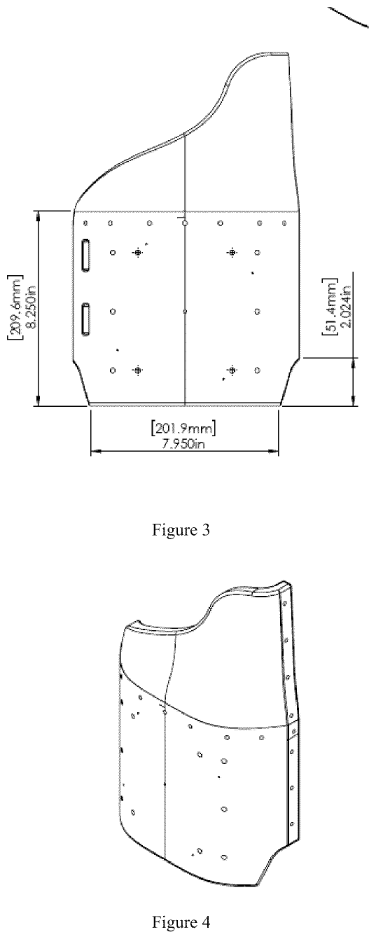

FIG. 3 is an illustrative perspective view showing the left-side motor support panel in accordance with some embodiments.

FIG. 4 is an illustrative front view of the left-side motor support panel in accordance with some embodiments.

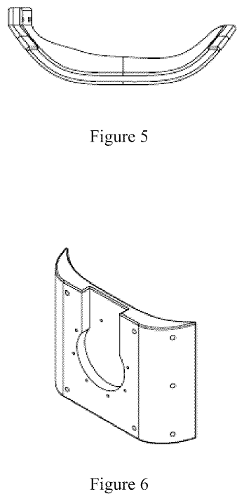

FIG. 5 is an illustrative top view of the left-side motor support panel in accordance with some embodiments.

FIG. 6 is a perspective view of a hip connector of the type connected to outer surfaces of the right-side motor support panel the left-side motor support panel.

FIG. 7 is an upward looking perspective exploded view of a left-side elongated rod, a left-side hip motor coupler, and a left-side thigh brace in accordance with some embodiments.

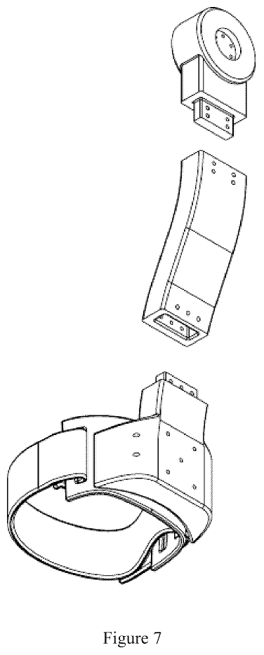

FIG. 8 is a downward looking perspective assembled view of the left-side elongated rod, the left-side hip motor coupler, and the left-side thigh brace in accordance with some embodiments.

FIG. 9 is an illustrative chart showing estimated torque required for hip joint movement of a user 1 and user 2.

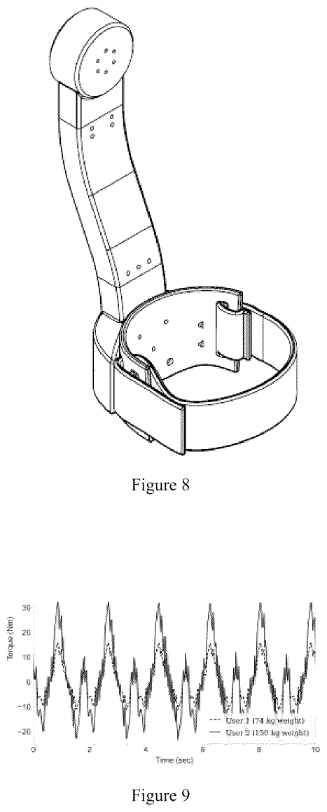

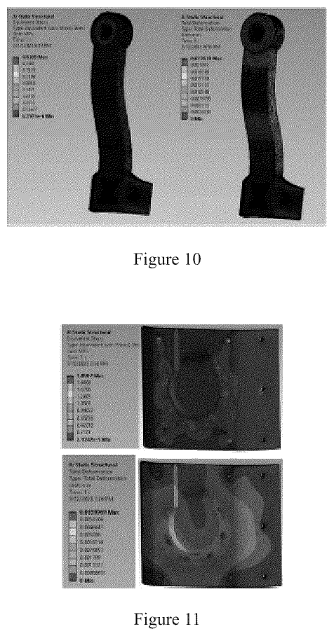

FIG. 10 is an illustrative drawing showing FEA results for example long hip components.

FIG. 11 is an illustrative drawing showing FEA results for an example hip connector part.

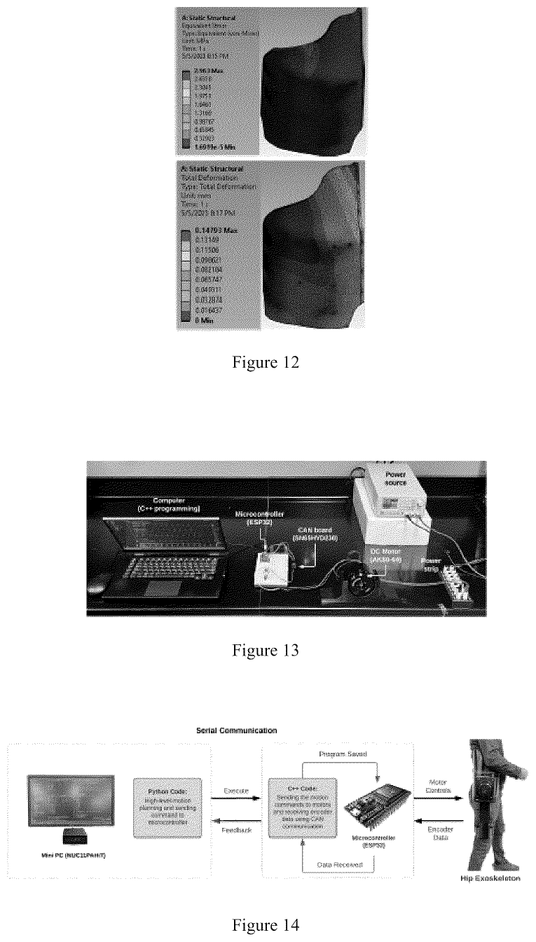

FIG. 12 is an illustrative drawing showing FEA results of the large trunk support component.

FIG. 13 is and illustrative drawing showing an experimental setup to test a control and actuation system including for a hip exoskeleton in accordance with some embodiments.

FIG. 14 is an illustrative drawing showing an example architecture of mechatronic hardware and software for the hip exoskeleton.

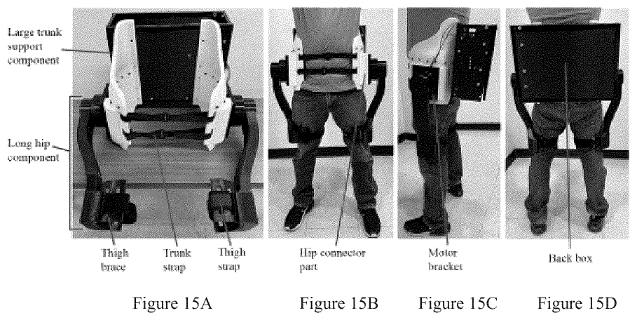

FIGS. 15A-15D are illustrative drawings showing components of the hip exoskeleton.

FIG. 15A is a front view of a fully assembled hip exoskeleton. FIG. 15B is a front view of a fully assembled hip exoskeleton mounted to a user.

FIG. 15C is a right-side view of a fully assembled hip exoskeleton mounted to a user.

FIG. 15D is a back view of a fully assembled hip exoskeleton mounted to a user.

### A3. DETAILED DESCRIPTION/Hip Exoskeleton

### Mechanical Overview of Hip Exoskeleton

FIG. 1 is a frontal left-side downward-looking perspective view of a hip exoskeleton mounted to an example mannequin in accordance with an example embodiment. FIG. 2 is a back right-side upward-looking perspective view of the hip exoskeleton mounted to the mannequin in accordance with an example embodiment. The example mannequin models a portion of the human anatomy that includes a hip portion and left and right thigh portions. As used herein, the term “proximal” refers to locations closer to the patient's hip region and the term “distal” refers to locations farther from the patient's hip region.

The hip exoskeleton includes a motor support structure that is mountable upon the hip portion of a patient. An example motor support structure includes a right-side motor support panel and a left-side motor support panel. A back-side panel interconnects a back portion of the right-side motor support panel and a back portion of the left-side motor support panel. More particularly, an example back-side panel interconnects a flange that extends along a back-edge portion of the right-side motor support panel and a flange that extends along a back-edge portion of the left-side motor support panel. A right-side hip connector is fixedly secured with fasteners an outer surface of the right-side motor support panel. A right-side hip motor is fixedly mounted upon a right-side hip motor bracket that is fixedly secured with fasteners such as screws to the right-side hip connector located on the outer surface of the right-side motor support panel. A right-side hip motor coupler is coupled for rotational motion imparted using the right-side hip motor. A left-side hip connector is fixedly secured with fasteners an outer surface of the left-side motor support panel. A left side hip motor is fixedly mounted upon a left-side hip motor bracket that is fixedly secured with fasteners such as screws to the left-side hip connector located on the outer surface of the left-side motor support panel. A left-side hip motor coupler is coupled for rotational motion imparted using the left-side hip motor. Adjustable front straps extend between and interconnect a front portion of the right-side panel and a front portion of the left-side panel. A generally c-shaped right-side thigh support brace is contoured to partially surround an outward facing portion of a patient's right thigh portion. An adjustable right-side thigh strap secures the right-side thigh support brace to the patient's right thigh. A generally c-shaped left-side thigh support brace is contoured to partially surround an outward facing portion of a patient's left thigh portion. An adjustable left-side thigh strap secures the left-side thigh support brace to the patient's left thigh. In an example embodiment, the front straps, the right-side thigh strap, and the left-side thigh straps may include Velcro strap material. A right-side elongated rod includes a first end portion secured to the right-side hip motor coupler and includes a second end portion fixedly coupled to the right-side thigh brace. A left-side elongated rod includes a first end portion secured to the left-side hip motor coupler and including a second end portion fixedly coupled to the left side thigh brace. A back-facing portion of an example back-side panel can act as a portion of a back mounting structure, positioned behind a patient's back, on which to mount components that can be used to power and control the right-side hip motor and the left-side hip motor. An example back mounting structure includes an enclosure, in the form of a box, in which to mount one or more batteries to power and electronics to control the hip motors. Cooling vents are formed in the example enclosure. An example back mounting structure also can mount right-side and left-side ankle motors and right-side and left-side knee motors.

FIG. 3 is an illustrative perspective view showing the left-side motor support panel showing a back-edge portion in accordance with some embodiments. A back portion of the left-side motor support panel is taller than a front region of the left-side motor support panel to leave room for a patient's arm swing near the front region and to provide a longer back-edge portion surface for connection to the back portion. FIG. 4 is an illustrative front view showing the front portion of the left-side motor support panel that includes slots to receive front straps and showing a forward-facing portion of a back-edge portion of the left-side motor support panel in accordance with some embodiments. FIG. 5 is an illustrative top view of the left-side motor support panel in accordance with some embodiments. The left-side motor support panel is configured to partially wrap around a patient's torso at the hip section with a front portion having a curvature to extend around in front of the patient at about the patient's pelvic area and with the back-edge portion having a curvature to extend behind the patient at about the patent's pelvic area. FIG. 6 is a perspective view of a hip connector of the type connected to outer surfaces of the right-side motor support panel the left-side motor support panel. The hip connector includes a cutout to accommodate a hip motor and to create a channel for electrical connection to a port on the hip motor that is set therein.

The right-side motor support panel has a complementary structure like that of the left-side motor support panel. Therefore, for economy of description, the right-side motor support panel will not be explained in detail since a person of ordinary skill in the art will understand the structure of the right-side motor support panel based upon the above description of the left-side motor support panel.

FIG. 7 is an upward looking perspective exploded view of the left-side elongated rod, a left-side hip motor coupler, and a left-side thigh brace in accordance with some embodiments. FIG. 8 is a downward looking perspective view of the left-side elongated rod, the left-side hip motor coupler, and the left-side thigh brace assembled into a unitary structure in accordance with some embodiments. The rod, coupler, and brace components can matingly interfit with one another as shown as shown in FIG. 8 and can be secured together with screws. An example elongated rod has a rectangular cross-section and has a contour that curves inward toward a patient's thigh starting at about midway between the first end portion of the rod and the second end portion of the rod. The left-side hip motor coupler has a disc shape. A portion of the outer perimeter of the disc is secured to the first end portion of the left-side elongated rod. The disc shaped left side hip motor coupler and the first end portion of the rod protrude laterally outward from the left-side motor support panel, since the disc-shaped coupler is rotatably secured to the left-side hip motor, which is mounted within the left-side hip motor bracket, which is secured to the left-side hip connector positioned upon the left-side motor support panel. The curvature of the distal portion of the rod toward the thigh, results in the second end portion of the rod being axially aligned close enough to the patient's left thigh that the c-shaped left-side thigh support brace can partially surround the patient's left thigh while the patient's thigh is laterally positioned substantially in at a neutral or rest position. That is, the thigh extends down from the hip without being offset outwardly or inwardly. A generally c-shaped semi-rigid cushioning material is secured to inner surface of the c-shaped left-side thigh support brace. Slots formed in end portions the c-shaped semi-rigid cushioning material can receive the left-side thigh straps, which can wrap around portions of a patient's thigh not encompassed by the c-shaped left-side thigh support and/or the c-shaped semi-rigid cushioning material. For economy of description, the right-side elongated rod, right-side hip motor coupler, and right-side thigh brace will not be further explained since they have complementary structures like that of the left-side elongated rod, the left-side hip motor coupler, and the left-side thigh brace.

In operation, the motor support structure secures the right-side motor and the left-side motor to locations adjacent to a patient's right and left hips, respectively, the right-side motor and the left-side hip motor impel a patient's left thigh and right thigh in coordinated complementary swinging pendular motion in which the left thigh and right thigh alternately take strides to achieve a walking motion. The right-side motor imparts cyclical partial forward rotation motion and partial backward rotation motion to the right-side hip motor coupler, which in turn, imparts corresponding pendular motion to the right-side elongated rod and the right-side thigh brace. The right-side thigh brace, which is secured about the patient's right thigh by the right-side thigh strap imparts the right-side pendular motion to the patient's right thigh. Similarly, the left-side motor imparts cyclical partial forward rotation motion and partial backward rotation motion to the left-side hip motor coupler, which in turn, imparts corresponding pendular motion to the left-side elongated rod and the left-side thigh brace. The left-side thigh brace, which is secured about the patient's left thigh by the left-side thigh strap imparts the left-side pendular motion to the patient's left thigh.

### Torque Calculation for Motor Selection

Assuming a single degree of freedom on the lower limb, the simple model of human leg movement can be modeled as an inverted pendulum, the torque required to move the leg can be obtained from the following equation:

$$τ = J \ddot{θ} + mgl sin ( θ ) \qquad ( 1 )$$

Where, τ is applied joint torque, J is the polar moment of inertia, θ is the angular displacement, \ddot{θ} is angular acceleration, m is the mass of the leg, g is the gravity, and/is the length of the pendulum representing the length of the leg.

The desired trajectory θ(t) of the exoskeleton is defined [24] as

$$θ ( t ) = {a}_{0} + {\sum }_{n = 1}^{∞} ( {a}_{n} cos ( n ω t ) + {b}_{n} sin ( n ω t ) ) \qquad ( 2 )$$

For user 1, we are considering a male subject of height 1.74 m, mass 74 kg traveling at an angular velocity (ω) of 3.5 rad/s. From the anthropometric data shown in R. Hari Krishnan et al., [25], the weight (m) of the hip/thigh can be approximated to be 18.5% of the total weight of the subject which is 13.69 kg. The length of the hip/thigh can be approximated to be 62.74% of the total sample length which is 1.09 m. The moment of inertia of the hip/thigh is approximated to be 1.38 kg·m2. The gravity (g) is 9.81 m/s².

TABLE I
COEFFICIENTS OF FOURIER SERIES EQ. (2) FOR THE HIP INITIAL MOTION FOR NORMAL GAIT TRAJECTORIES,
[24]

| State | Joint | a₀ | a₁ | a₂ | a₃ | a₄ | a₅ | a₆ | a₇ | a₈ | b₁ | b₂ | b₃ | b₄ | b₅ | b₆ | b₇ | b₈ |
|---|---|---|---|---|---|---|---|---|---|---|---|---|---|---|---|---|---|---|
| Walking | Hip | 10.13 | 21.80 | −5.07 | −0.49 | −0.52 | 0.20 | −0.07 | −0.09 | −0.09 | −10.77 | −2.21 | 1.86 | 0.41 | 0.20 | −0.06 | −0.05 | −0.05 |

Similarly, for user 2, we are considering a male subject of height 1.92 m, mass 150 kg traveling at an angular velocity (ω) of 3.5 rad/s. According to the anthropometric data in [25], the weight (m) of the hip/thigh can be approximated to be 18.5% of the total weight of the subject which is 27.75 kg. The length of the hip/thigh can be approximated to be 62.74% of the total sample length which is 1.20 m. Also, the moment of inertia of the hip/thigh is approximated to be 2.78 kg·m². The gravity (g) is 9.81 m/s².

The experiments performed by Sharifi et al. [24] shown in Table II are used for the coefficient of the Fourier series for the hip motion for normal gait trajectories to calculate the maximum torque.

FIG. 9 is an illustrative chart showing estimated torque required for hip joint movement of a user 1 (74 kg weight) and user 2 (150 kg weight). From FIG. 9, we could see that the maximum torque needed to support the hip movement for user 1 and user 2 is around 13 Nm and 33 Nm respectively. The CubeMars AK80-64 motor, that we have selected for the project provides a maximum torque of 48 Nm and will be enough to support the hip movement.

### Structural Design of an Example Hip Exoskeleton

The design of the example hip exoskeleton was focused on achieving three main objectives, which were to make it lightweight, provide high torque, and keep the cost low. Before creating the current example hip exoskeleton shown in FIGS. 1-2, two initial designs of the hip exoskeleton were developed with the goals of reducing stress and strain on the components and improving the user's experience. The master model technique was used to ensure that all the individual components of the hip exoskeleton are designed to fit together perfectly without alignment issues. The master model is created first, and then each component is exported for assembly. This helps to ensure that the final product is seamless, and functions as intended. A CAD model of the hip component was designed to accommodate users within a range of heights and weights, including user 1 with a height of 1.74 m and a weight of 74 kg, and user 2 with a height of 1.92 m and a weight of 150 kg, to ensure that it can be used by a broad range of individuals. Different tools and techniques available in SOLIDWORKS, including extruded boss/cut, sweep, loft, surface features, and split, are utilized to create the design of the hip exoskeleton components. In addition, materials are assigned to each component to assess the weight of the exoskeleton.

The CAD design of the initial hip exoskeleton was updated after selecting the materials for the components, determining the required torque, and selecting motors for the actuator. The revised CAD model of the hip exoskeleton is illustrated in FIGS. 1-2, which display a front perspective view and a back perspective view, respectively. This revised CAD model of the hip exoskeleton incorporates diverse components, including motors, motor covers, long hip components, hip connectors, thigh brace, mounting screws, thigh straps, a large trunk support component, and a back box. To manufacture these components, various filaments such as Polylactic acid (PLA), thermoplastic polyurethane (TPU), and polyethylene terephthalate glycol (PETG) were used through 3D printing technology. All components are designed to withstand the maximum nominal torque from the motor, which is 48 Nm [26]. The upper half of the large trunk support component (as shown in FIG. 2) is curved to rest on the wearer's pelvis, providing extra support from the trunk and preventing the entire assembly from slipping down. A back box is composed of carbon fiber composite plates and PETG plates. A front and back plate on the back box is made from carbon fiber sheets to have high strength for fixing the left and right leg sub-assembly of the hip exoskeleton. The back box is also designed to accommodate four motors as additional actuators for respective left and right knee and ankle joints. These actuators will use a cable-driven system to support the knee and ankle parts on the next version of the lower limb exoskeleton.

### Static Structural Analysis on a Long Hip Component and Hip Connector Part

Static structural analysis is performed on the long hip components (coupler, rod, and brace) hip connector part, and large trunk support component (right-side and left-side motor support panels) of the exoskeleton using Ansys to ensure that the components withstand the load from the hip joint movement. The long hip component is one of the key components of the hip exoskeleton which transmit the torque from the motor to the thigh to support the hip joint movement and experiences large stress and strain. To perform the analysis, forces acting on the components and boundary conditions have been determined. Since the motor is connected to the hip component using six bolts and nuts, the torque from the motor can be modeled as the forces acting on the screw holes on the long hip component. The total forces acting on the six holes is determined to be a total of 3,430 N. For the analysis, the force of 570 N is applied to each hole in a perpendicular direction on the long hip component and gravity is applied. The cutout section on the hip component closer to the screw holes is assumed as cylindrical support and the bottom section of the long hip component is assumed to be fixed at all the screw holes. A new PLA material (PLA 0.5) with properties of 50% infill is created in the Ansys based on the test result from S. R. Subramaniam et al. [27]. PLA 0.5 is assigned as material for the hip component to perform the analysis. Adaptive sizing for the mesh with resolution 7 is used for the mesh, followed by 3 mesh refinement to make sure the result converges within 5 percent.

FIG. 10 is an illustrative drawing showing FEA results for an example long hip components (coupler, rod, and brace) FIG. 10 left shows stress plot (maximum stress of 4.84 MPa) and FIG. 10 right shows deformation plot (maximum deformation of 0.023 mm). More particularly, FIG. 10 left results demonstrated that the hip component will experience maximum stress of 4.84 MPa around the holes at the top circular section. Due to the anticipated cyclic loading, it is crucial to investigate the fatigue behavior of the components. Although some studies have examined the fatigue behavior of PLA and constructed an S-N curve for a specific load condition, the data for the curve was not included in the paper to import into Ansys and add to the material (PLA 0.5) used on this project, making it challenging to conduct fatigue analysis in Ansys. However, based on the paper by Müller et al. the tensile properties of the PLA will only reduce by 7.2% if the cyclic load is less than 50% of the material ultimate tensile strength [28]. Since, the long hip component will only experience the maximum load of 4.84 MPa which is under 50% of the material ultimate tensile strength of PLA 0.5, 18.623 MPa [27], the part will be able to support the cyclic load from the motor and hip movement. Similarly, FIG. 10 right shows that the maximum deformation of 0.023 mm occurs around the holes through which the long hip component is secured to the motor using bolts and nuts and is under the tolerance of 0.2 mm maximum deformation. The long hip component has a factor of safety (FOS) of 3.23. From the analysis, we could confirm that the long hip component will support the load from hip movement.

The hip connector part shown in FIG. 2 is another key component of the exoskeleton that connects the long hip component and motor to the large trunk support component to create a sub-assembly for one leg of the user on the hip exoskeleton. For the analysis, PLA 0.5 is assigned as the material with properties of infill 50%. The hip connector will fix the motor to the large trunk support component and will need to withstand the torque from the motor. The motor is secured to the hip connector part using eight screws, the torque from the motor can be modeled as the forces acting on the screw holes on the hip connector part. The total forces acting on the eight holes are determined to be a total of 1130 N. For the analysis, the force of 142 N is applied to each hole in a perpendicular direction on the hip connector part and gravity is applied. The hip connector part is secured to the large trunk component using ten bolts and nuts, so the part is assumed to be fixed on those surfaces. For meshing, adaptive sizing for the mesh with resolution 7 is used for the mesh, followed by 3 mesh refinement to make sure the result converges within 5 percent.

FIG. 11 is an illustrative drawing showing FEA results for an example hip connector part. FIG. 11 left shows stress plot (maximum stress of 1.89 MPa) and FIG. 11 right shows deformation plot (maximum deformation of 0.005 mm). More particularly, FIG. 11 top shows that the component will experience maximum stress of 1.89 MPa at the holes where the motor gets connected which is under 50% of the material ultimate tensile strength of PLA 0.5, 18.623 MPa [27], the part will be able to support the cyclic load from the motor and hip movement. FIG. 11 bottom shows a maximum deformation of 0.005 mm will occur around the holes through which the hip connector is connected with the motor and is under the tolerance of 0.2 mm maximum deformation. The hip connector part has a FOS of 8.25. Per the FEA result, we could confirm that the hip connector part will be able to withstand the load from the hip movement.

FIG. 12 is an illustrative drawing showing FEA results of the large trunk support component (right-side/left-side motor support panels). FIG. 12 top shows stress plot (maximum stress of 2.963 MPa) and FIG. 12 bottom-deformation plot (maximum deformation of 0.147 mm). The large trunk support component illustrated in FIG. 12 is one of the largest components in the hip exoskeleton and it supports and fixes the sub-assembly of the long hip component for each leg. The large trunk support component for the left and right leg is connected to the back box which houses the battery and electronics for the hip component. The back box also is designed to house the two actuator setups for the knee exoskeleton and two actuators for the ankle exoskeleton to create a complete lower limb exoskeleton. Therefore, the large trunk component needs to support the weight of the back box including the actuators setup for the knee and ankle as well as the torque from the motor. PLA 0.5 is used as a material to perform the analysis. The hip connector part that fixes the motor will be secured to the large trunk component using ten bolts and nuts on the side and will need to support the torque from the motor as well as the weight of the long hip component sub-assembly. The total forces acting on the ten holes are determined to be 620 N. For the analysis, a total force of 62 N is applied to each hole in a perpendicular direction on the large trunk support component. Additionally, the load from the back box, motors, and other components is determined to be 26.75 N for each large trunk support component and will be supported by seven holes on the back. Similarly, For meshing, adaptive sizing for the mesh with resolution 7 is used for the mesh, followed by 3 mesh refinement to make sure the result converges within 5 percent. Similarly, FIG. 12 top shows that the component will experience maximum stress of 2.96 MPa at the holes where the hip connector gets connected which is under 50% of the material ultimate tensile strength of PLA 0.5, 18.623 MPa [27], the part will be able to support the cyclic load from the motor and back box. FIG. 12 bottom shows a maximum deformation of 0.147 mm that will occur around the top and around the holes through which the hip connector is connected and is under the tolerance of 0.2 mm maximum deformation. The large trunk support component has a FOS of 5.26. Per the FEA result, we could confirm that the large trunk support component will be able to withstand the load from the hip movement and back box.

### CAD Models and 3D-Printed Components of an Example Hip Exoskeleton

This section covers the CAD models and 3D-Printed components of the hip exoskeleton in polylactic acid (PLA), thermoplastic polyurethane (TPU), and polyethylene terephthalate glycol (PETG) filaments. The CAD model, 3D-printed long hip components, and thigh brace sub-assembly of the exoskeleton are depicted in FIGS. 6-7. The long hip component is 3D printed using PLA with 50% infill. The circular upper portion of the hip component, which connects to the motor, has a diameter of 3.5 inches and a depth of 1.75 inches. Likewise, the middle rigid frame is made from a curved rectangular tube that measures 2.75 inches in width and 1.25 inches in thickness and connects to the 4-inch by 0.375-inch-thick thigh brace. The three-part hip component is displayed in an exploded view in FIG. 7, where it can be seen that it is assembled using screws and nuts. The thigh brace, which is shown in FIGS. 1, 2, 6, 7, is printed with 70% infill using TPU material, and it measures CA.25 inches in diameter and 4 inches in height. To ensure proper attachment to the thigh, an additional slot is included in the thigh brace, creating a Velcro locking system. The Velcro strap is utilized on the thigh brace to enable adjustment for users of various sizes.

A motor bracket and hip connector, illustrated in FIGS. 1-2, are designed to hold the DC motor (AK80-64) firmly in place on the large trunk support component. All components are 3D printed using PLA with 50 percent infill to ensure they can handle the maximum loading conditions. The large trunk support component (right-side/left-side motor support panels) has a curved surface at the upper section which is designed to sit on the user's pelvis to provide additional support and prevent it from sliding down from the hip. It has a dimension of 8.875-inch width×3.75-inch depth×15-inch height, which is the largest component in the hip exoskeleton 3D printed in PLA material. Similar to the long hip component, this part is made in two pieces, a top piece, and a bottom piece to be able to print in readily available 3D printers. The top and bottom pieces are bolted together to make a single piece. This component serves as a base to fix all the other components together around the wearer's trunk. An example hip connector part has dimensions of 7.78-inch width×6-inch depth×0.75-inch thickness had a cutout at the center and top to accommodate the motor and create a channel for the connection port on the motor. The motor is connected from the back using machine screws to the hip connector part. The right and left leg sub-assembly of all the components is connected using the back box which is illustrated in FIGS. 3 and 9. It is made by combining front and back carbon fiber composite plates and PETG plates. It is 16.5 inches×12 inches×5.75 inches. The carbon fiber plates are fabricated by layering carbon fiber sheets onto both surfaces on a foam sheet. Additional holes are added to the back support plate to allow the hip exoskeleton to be adjusted up to 4 inches in width to accommodate users with different waists.

FIGS. 15A-15D are illustrative drawings showing components of the hip exoskeleton. FIG. 15A is a front view of a fully assembled hip exoskeleton. FIG. 15B is a front view of a fully assembled hip exoskeleton mounted to a user. FIG. 15C is a right-side view of a fully assembled hip exoskeleton mounted to a user. FIG. 15D is a back view of a fully assembled hip exoskeleton mounted to a user.

### Mechatronics Development

In this section, a breakdown of the mechatronic setup to test the developed hip exoskeleton is described. The control hardware of this exoskeleton includes a microcontroller, actuators, and intermediate boards, and a power supply, as shown in FIG. 13. The microcontroller for this exoskeleton's mechatronic system is the ESP-Wroom-32 with two cores and 240 MHz of memory speed. The SN65HVD230 CAN board (from AITRIP) is used as an intermediate board to communicate between the ESP 32 and the motor for sending and receiving CAN signals. This configuration (FIG. 13) enables a bilateral signal communication with the AK80-64 motors (from T-Motor) that has an input port for the CAN protocol. The RD6018 DC power supply, with an output voltage range of 44-60 volts, is used for testing purposes. An Intel NUC11PAHi7 mini-PC is utilized to execute the main Python code for the control of the exoskeleton with the ESP32 microcontroller.

This lower-limb assistive exoskeleton has been designed to move the hip joints with the capability of applying the maximum torque needed to move the hip joint, which is reported 60 Nm [29]. The employed brushless DC motor (AK80-64) has a high output torque, a lightweight, and a compact design (FIGS. 4, 5 and 6). This motor has a nominal torque of 48 Nm and a maximum peak torque of 120 Nm.

### Hardware and Software Architecture

FIG. 13 is and illustrative drawing showing an experimental setup to test a control and actuation system including AK80-64 DC motors, ESP-Wroom-32 as the microcontroller and SN65HVD230 CAN board. The employed power supply can deliver 48 V with a maximum current of 18 Amps to the motors. The ESP 32 microcontroller is connected to the CAN board to provide communication with the motor containing two 10 kOhm resistors.

FIG. 14 is an illustrative drawing showing an example architecture of mechatronic hardware and software for the hip exoskeleton: Python code is executed on PC for motion planning and C++ code is executed on microcontroller for CAN communication with motors. As described in FIG. 14, the motor control program is written in C++ using Visual Studio and the PlatformIO IDE as the user interface. The program was developed based on the AK80-64 Series actuator driver manual v1.0.9 that includes steps to transfer the C++ program into CAN communication for driving the motor [30]. The motor sends back bits of data that had to be reorganized to obtain motor position, speed, current, temperature, and errors. Based on the manufacturer's recommendation and a trial-and-error approach to achieving appropriate tracking performance for hip movements, the position control parameters of the DC motor have been set at kₚ=420 N·m/rad and K_{d}=4.5 N·m·sec/rad. This was according to the hip motion's amplitude and speed in different activities including walking and sit-to-stand.

### A4. REFERENCES/Hip Exoskeleton

[1] A. Esquenazi, M. Talaty, A. Packel, and M. Saulino, “The ReWalk powered exoskeleton to restore ambulatory function to individuals with Thoracic-Level Motor-Complete spinal cord injury,” Am. J. Phys. Med. Rehabil., vol. 91, no. 11, p. 911, November 2012.
[2] P. Dilokthornsakul, R. J. Valuck, K. V. Nair, J. R. Corboy, R. R. Allen, and J. D. Campbell, “Multiple sclerosis prevalence in the united states commercially insured population,” Neurology, vol. 86, no. 11, pp. 1014-121 March 2016.
[3] “Spinal cord injury.” [Online]. Available: https://www.ninds.nih.gov/Disorders/All-Disorders/Spinal-Cord-Injury-Information-Page
[4] Y. Chen, Y. Tang, L. Vogel, and M. DeVivo, “Causes of Spinal Cord Injury,” Topics in Spinal Cord Injury Rehabilitation, vol. 19, no. 1, pp. 1-8, 01 2013. [Online]. Available: https://doi.org/10.1310/sci1901-1
[5] A. Kapsalyamov, P. K. Jamwal, S. Hussain, and M. H. Ghayesh, “State of the art lower limb robotic exoskeletons for elderly assistance,” IEEE Access, vol. 7, pp. 95 075-95 086, 2019.
[6] “Chapter 11—lower limb exoskeleton systems—overview,” in Wearable Robotics, J. Rosen and P. W. Ferguson, Eds. Academic Press, 2020, pp. 207-229. [Online]. Available: https://www.sciencedirect.com/science/article/pii/B9780128146590000114
[7] S. A. Murray, R. J. Farris, M. Golfarb, C. Hartigan, C. Kandilakis, and D. Truex, “Fes coupled with a powered exoskeleton for cooperative muscle contribution in persons with paraplegia,” in 2018 40th Annual International Conference of the IEEE Engineering in Medicine and Biology Society (EMBC), 2018, pp. 2788-2792.
[8] P. Stegall, K. Winfree, D. Zanotto, and S. K. Agrawal, “Rehabilitation exoskeleton design: Exploring the effect of the anterior lunge degree of freedom,” IEEE Transactions on Robotics, vol. 29, no. 4, pp. 838-846, 2013.
[9] G. Zeilig, H. Weingarden, M. Zwecker, I. Dudkiewicz, A. Bloch, and A. Esquenazi, “Safety and tolerance of the Rewalk™ exoskeleton suit for ambulation by people with complete spinal cord injury: A pilot study,” The Journal of Spinal Cord Medicine, vol. 35, no. 2, pp. 96-101, 2012, pMID: 22333043. [Online]. Available: https://doi.org/10.1179/2045772312Y.0000000003
[10] M. Wehner, B. Quinlivan, P. M. Aubin, E. Martinez-Villalpando, M. Baumann, L. Stirling, K. Holt, R. Wood, and C. Walsh, “A lightweight soft exosuit for gait assistance,” in 2013 IEEE International Conference on Robotics and Automation, May 2013, pp. 3362-3369.
[11] A. Rodríguez-Fernández, J. Lobo-Prat, and J. M. Font-Llagunes, “Systematic review on wearable lower-limb exoskeletons for gait training in neuromuscular impairments,” J. Neuroeng. Rehabil., vol. 18, no. 1, p. 22, February 2021.
[12] “Ekso bionics webpage.” [Online]. Available: https://eksobionics.com/eksonr/“Cyberdyne webpage.” [Online]. Available: https://www.cyberdyne.jp/english/products/LowerLimb_medical.html
[14] Kawamoto and Sankai, “Power assist method based on phase sequence and muscle force condition for HAL,” Prod. Pharm.
[15] “Rewalk™ personal 6.0 exoskeleton for spinal cord injury,” June 2021. [Online]. Available: https://rewalk.com/rewalk-personal-3/
[16] “Indego webpage.” [Online]. Available: https://www.indego.com/indego/us/en/home
[17] Y. Lee, S.-G. Roh, M. Lee, B. Choi, J. Lee, J. Kim, H. Choi, Y. Shim, and Y.-J. Kim, “A flexible exoskeleton for hip assistance,” 2017.
[18] M. Yang, Q. Zhu, R. Xi, X. Wang, and Y. Han, “Design of the power-assisted hip exoskeleton robot with hydraulic servo rotary drive,” in 2016 23rd International Conference on Mechatronics and Machine Vision in Practice (M2VIP), November 2016, pp. 1-5.
[19] K. Seo, J. Lee, and Y. J. Park, “Autonomous hip exoskeleton saves metabolic cost of walking uphill,” in 2017 International Conference on Rehabilitation Robotics (ICORR), July 2017, pp. 246-251.
[20] T. Zhang, M. Tran, and H. Huang, “Design and experimental verification of hip exoskeleton with balance capacities for walking assistance,” IEEE/ASME Transactions on Mechatronics, vol. 23, no. 1, pp. 274-285, 2018.
[21] D. Zhang, Y. Ren, K. Gui, J. Jia, and W. Xu, “Cooperative control for a hybrid rehabilitation system combining functional electrical stimulation and robotic exoskeleton,” Frontiers in Neuroscience, vol. 11, 2017. [Online]. Available: https://www.frontiersin.org/articles/10.3389/fnins.2017.00725
[22] A. Esquenazi, M. Talaty, and A. Jayaraman, “Powered exoskeletons for walking assistance in persons with central nervous system injuries: A narrative review,” PMR, vol. 9, no. 1, pp. 46-62, 2017. [Online]. Available: https://www.sciencedirect.com/science/article/pii/S1934148216308796
[23] Z. Li, K. Zhao, L. Zhang, X. Wu, T. Zhang, Q. Li, X. Li, and C.-Y. Su, “Human-in-the-loop control of a wearable lower limb exoskeleton for stable dynamic walking,” IEEE/ASME Transactions on Mechatronics, vol. 26, no. 5, pp. 2700-2711, 2021.
[24] M. Sharifi, J. K. Mehr, V. K. Mushahwar, and M. Tavakoli, “Autonomous locomotion trajectory shaping and nonlinear control for lower limb exoskeletons,” IEEE/ASME Transactions on Mechatronics, vol. 27, no. 2, pp. 645-655, 2022.
[25] R. Hari Krishnan, V. Devanandh, A. K. Brahma, and S. Pugazhenthi, “Estimation of mass moment of inertia of human body, when bending forward, for the design of a self-transfer robotic facility,” vol. 11, no. 2, pp. 166-176, 2016.
[26] “Ak80-64motor.” [Online]. Available: https://store.cubemars.com/goods.php?id=1143
[27] S. R. Subramaniam, M. Samykano, S. K. Selvamani, W. K. Ngui, K. Kadirgama, K. Sudhakar, and M. S. Idris, “Preliminary investigations of polylactic acid (PLA) properties,” AIP Conference Proceedings, vol. 2059, no. 1, 01 2019, 020038. [Online]. Available: https://doi.org/10.1063/1.5085981
[28] M. Müller, V. ^{̌ Šleger, V. Kolář, M. Hromasová, D. Piš, and R. K. Mishra, “Low-Cycle fatigue behavior of} 3D-Printed PLA reinforced with natural filler,” Polymers, vol. 14, no. 7, March 2022.
[29] Y. M. Pirjade, D. R. Londhe, N. M. Patwardhan, A. U. Kotkar, T. P. Shelke, and S. Ohol, “Design and fabrication of a low-cost human body lower limb exoskeleton,” in 2020 6th International Conference on Mechatronics and Robotics Engineering (ICMRE), 2020, pp. 32-37.
[30] “Ak series actuator manual.” [Online]. Available: https://store.tmotor.com/images/file/202208/251661393360838805.pdf.

### B. Hip Exoskeleton Mechatronics

### B1. BRIEF DESCRIPTION OF THE DRAWINGS/Hip Exoskeleton Mechatronics

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

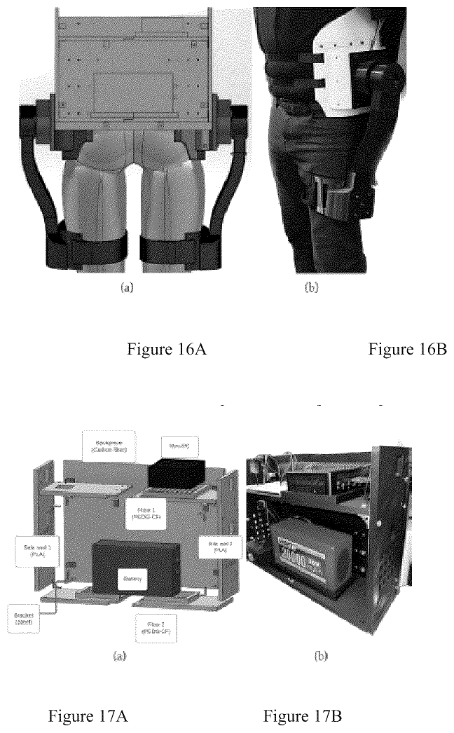

FIGS. 16A-16B are a back view design (FIG. 16A) and fabricated side view (FIG. 16B) hip exoskeleton device with motors on each side and leg brace connecting to the thigh.

FIGS. 17A-17B are a front view design (FIG. 17A) and fabricated (FIG. 17B) mechatronic storage device for the mini-pc, battery, and intermediary boards.

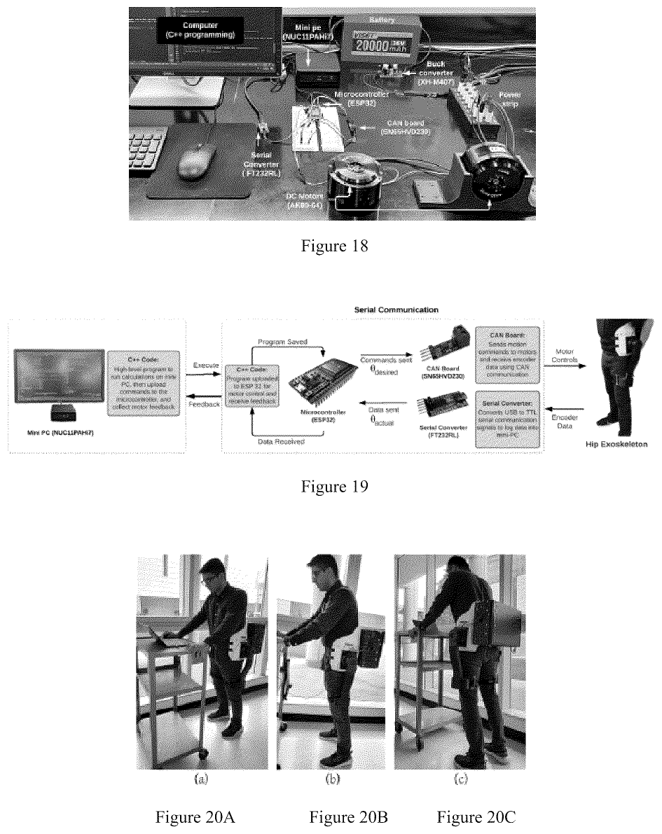

FIG. 18 is a mechatronics system including the mini-pc, motors, and intermediary boards to run our components for controlling and testing the AK80-64 motors.

FIG. 19 is a mechatronics communication between the Mini-PC and motors for the hip exoskeleton: C++ code is uploaded on the microcontroller for CAN communication with motors and data is received back using a FT232RL serial converter.

FIGS. 20A-20B are a front view (FIG. 20A) Side view (FIG. 20B) Back view (FIG. 20C) hip exoskeleton testing device with motors on each side and leg brace connecting to the thigh.

FIG. 21 is a tracking a typical hip trajectory using Kₚ=100 in a typical walking with the frequency of 1.8 rad/sec.

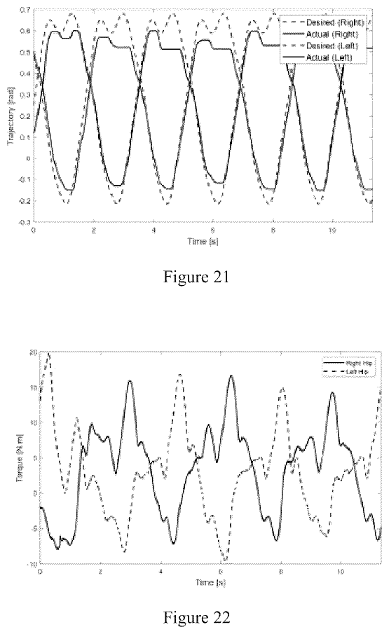

FIG. 22 is a delivered motor torque during walking with the speed of 1.8 rad/sec with Kₚ=100.

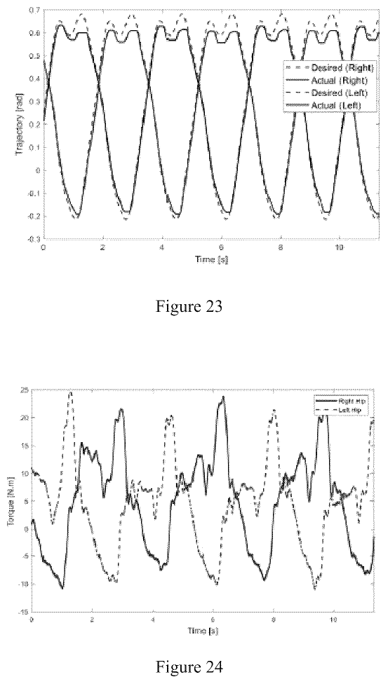

FIG. 23 is a tracking a typical hip trajectory using Kₚ=300 in a typical walking with the frequency of 1.8 rad/sec.

FIG. 24 is a delivered motor torque during walking with the speed of 1.8 rad/sec with Kₚ=300.

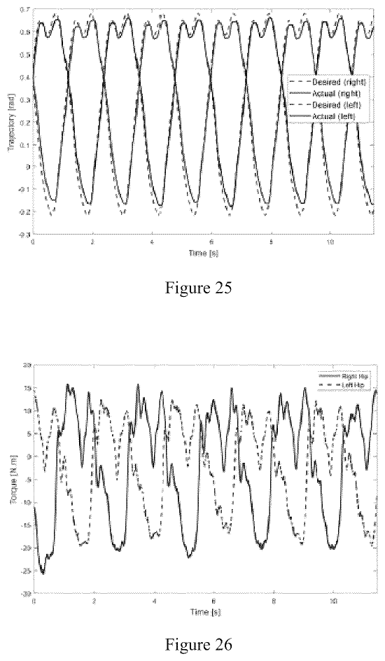

FIG. 25 is a delivered motor torque during walking with the speed of 2.5 rad/sec with Kₚ=300.

FIG. 26 is a delivered motor torque during walking with the speed of 2.5 rad/sec with Kₚ=300.

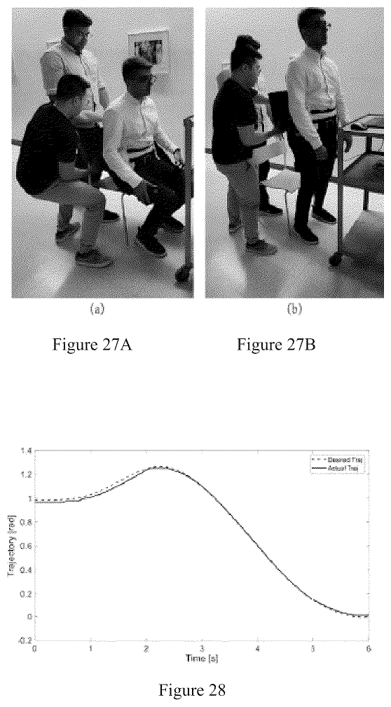

FIGS. 27A-27B are a sitting (FIG. 27A) Standing (FIG. 27B) procedure when the human user has the hip exoskeleton testing device attached to their limbs.

FIG. 28 is a sit-to-stand trajectory tracking for a 6 sec period.

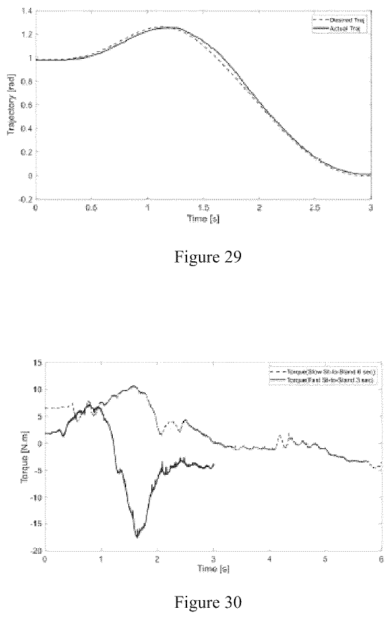

FIG. 29 is a sit-to-stand trajectory tracking for a 3 sec period.

FIG. 30 is an applied motor torque for sit-to-stand motion within two time Periods (6 sec and 3 sec).

### B2. DETAILED DESCRIPTION/Hip Exoskeleton Mechatronics

### Mechatronics Development

The mechanical systems for testing a new exoskeleton design will be focused in this section. The control hardware components of the exoskeleton, such as the microcontroller, actuators, intermediate boards, and 36 V battery, are depicted in FIG. 3. The chosen microcontroller for this project was an ESP32 for its high 240 Mhz memory speed. An Intel NUC11PAHi7 mini-PC executes the main C++ code into the ESP32 microcontroller which relays it towards the SN65HVD230 CAN board (from AITRIP) to move the motors. The SN65HVD230 CAN board enables bilateral communication for sending and receiving CAN signals from the AK80-64 motors (from T-motors). This configuration (FIG. 18) shows how the communication is being sent and received based on our commands from the C++ code. Also, a Lithium-ion battery (36V, 20 Ah) will be used to power the motors, mini PC, and intermediary boards. Lastly, an XH-M407 buck converter was used with the battery to regulate its voltage to 19 V and had 200 W to power the mini-PC requiring 120 W.

Designed to move the hip joints, this lower-limb assistive exoskeleton is capable of applying the maximum torque necessary to move the hip joints, reported to be an estimated 60 Nm [12]. With its high torque output, lightweight, and compact design, the brushless DC motor (AK80-64) is suitable for the application (FIGS. 1 3 and 4). In addition to its compact structure, the motors can maintain a nominal torque of 48 Nm and a peak torque of 120 Nm.

### Hardware and Software Architecture

A schematic of the experimental setup of the mechatronic system used to test and control the motors is shown in FIG. 3. The lithium-ion battery will provide the mechatronics system with 36 V with a maximum current of 20 Ah to the motors and mini-PC. A CAN transceiver is connected to the ESP 32 microcontroller so that it can communicate with the motor. Additionally, two 120Ω resistors are connected to the CAN transceiver to have terminating resistances to have serial bus communication to the motors. As presented in FIG. 19, C++ was used because it is faster to compile and integrates the PaltformIO IDE with Visual Studio. To operate the AK80-64 motors the script configuration was found in the T-motors manual v1.0.9 [35] that had C++ code to utilize the motors CAN communication. It is necessary to restructure the data sent by the motor in order to obtain information about its position, speed, or current. A proportional-derivative controller was used with the gains set to Kₚ=495 N·m/rad and K_{d}=4.5 N·m·sec/rad for the motors from the information provided in the manual and testing. Different activities, such as walking were controlled for hip motion amplitude.

### Experimental Evaluations

To develop an operational hip exoskeleton the empirical data was gathered from past lower-limb walking studies for walking and sit-to-stand movements in [36] and [37], respectively. Using these trajectories the newly built hip exoskeleton could be tested. The trajectories were then added into a Fourier series with 5-6 terms to determine a continuous movement. The tracking data could then be fed into the motor to receive the positional encoder feedback from the motor. The desired movements q_{w}_{ᵢ}(t) for the joint i of the exoskeleton were defined as

$${q}_{des} ( t ) = {a}_{0} + {\sum }_{k = 1}^{N} ( {a}_{k} cos k {θ}_{i} ( t ) + {b}_{k} sin k {θ}_{i} ( t ) ) \qquad ( 1 )$$

while the Fourier series with N terms includes the coefficients aₖ and bₖ. In order to attain the best fit, with the least amount of error compared to empirical trajectories, the coefficient aₖ and bₖ values were determined. In (Table I), these values are stated. The AK80-64 positional encoder was used to determine the accuracy based on the desired trajectory given to the motor. Two AK80-64 motors were used and tested to find the performance and synchronization behavior based on the code given to the motors.

### User Study

Experimental human trials were conducted on the exoskeleton for walking patterns to validate the motors' accuracy and their tracking behavior. They were installed into the hip exoskeleton depicted in FIGS. 20A-20C. In this section, empirical results of using the developed hip exoskeleton by an able-bodied individual (34 years old) in walking and sit-to-stand movements are analyzed. In these tests, two walking speeds of 1.8 rad/sec and 2.5 rad/sec and two Kₚ gain values (100 and 300) were employed based on the preference of the user. Further studies were performed for sit-to-stand movements with both slow and fast transitions, with 6-second and 3-second periods, respectively. The actual position of the hip joint was obtained from the encoder embedded in the motor. The tracking performance of the exoskeleton in walking (with a frequency of 1.8 rad/sec) with different Kₚ values is illustrated in FIGS. 6 and 8. As seen, two full strides were made in the span of 11 seconds but the maximum peak error for each Kₚ value was different from the other. For Kₚ=100 (FIG. 21), the highest error observed was 0.196 rad and at Kₚ=300 (FIG. 22), the peak error measured was 0.081 rad. This indicates that when the Kₚ is increased the accuracy of the motor increases. When aiming for greater accuracy, the motors will exert a large torque effort to attain the intended trajectory, resulting in elevated torque values, as depicted in FIGS. 7 and 9. At Kₚ=100, the maximum torque recorded is 19.7 Nm and at Kₚ=300, it reaches 24.3 Nm.

TABLE II
HIP COEFFICIENTS FOR WALKING TRAJECTORIES FOUND USING FOURIER SERIES.*

| State | Joint | a₀ | a₁ | a₂ | a₃ | a₄ | a₅ | a₆ | b₁ | b₂ | b₃ | b₄ | b₅ | b₆ |
|---|---|---|---|---|---|---|---|---|---|---|---|---|---|---|
| Walking | Hip | 40.69 | 23.22 | −4.49 | 0.40 | 0.70 | 1.08 | −0.27 | −8.65 | 3.34 | 1.39 | 0.80 | 0.34 | 0.07 |
| Sit-to-Stand | Hip | 49.59 | 22.01 | −1.31 | 0.28 | −0.72 | 0.15 | n/a | 35.11 | −11.48 | −4.05 | −0.16 | 0.40 | n/a |

Adjusting the controller gain involves a trade-off: higher Kₚ values result in smaller errors, while lower errors offer more flexibility but deviate from the desired trajectory. After determining a nominal Kₚ value of 300, the walking speed was increased to 2.5 rad/sec, revealing another observed deviation in FIG. 10. Even with a high value, the peak trajectories diverge from the desired trajectories due to the increased speed, placing significant strain on the motors and necessitating higher torque to move the legs, as depicted in FIG. 26. The maximum recorded error reached 0.086 rad, which is higher than the 0.081 rad maximum error observed during slower walking at 1.8 rad/sec with Kₚ=300. This demonstrates that fast speeds introduce deviation, even with high Kₚ values. Regarding this, the average torque applied by the motor on the right hip was 10.3 Nm for 2.5 rad/sec speed (FIG. 26), which is 19% higher than 8.6 Nm as the average of the same joint's torque at 1.8 rad/sec speed (FIG. 9).

The hip exoskeleton was also tested in a sit-to-stand transition demonstrated in FIGS. 27A-B. The actual and desired hip trajectories in this movement scenario are shown in FIGS. 28-29. The tracking performance of the exoskeleton in two different periods of this transition between the “sit” and “stand” states is demonstrated. With a 6-second window for this transition, the maximum tracking error was 0.0356 rad in FIG. 28, which resulted in the highest motor torque of 10.68 Nm in FIG. 15. Moreover, when the sit-to-stand time window was decreased to 3 seconds (fast transition scenario), the maximum tracking error increased to 0.059 rad in FIG. 14, and the motor torque increased to 17.7 Nm in FIG. 30. Comparing these results indicates that higher sit-to stand speed and acceleration of the hip trajectory can impact the tracking error and required torque magnitude.

### B3. REFERENCES/Hip Exoskeleton Mechatronics

[1] “Spinal cord injury,” National Institute of Neurological Disorders and Stroke, 2023. [Online]. Available: https://www.ninds.nih.gov/Disorders/All-Disorders/Spinal-Cord-Injury-Information-Page
[2] Y. Chen, Y. Tang, L. Vogel, and M. DeVivo, “Causes of Spinal Cord Injury,” Topics in Spinal Cord Injury Rehabilitation, vol. 19, no. 1, pp. 1-8, 01 2013. [Online]. Available: https://doi.org/10.1310/sci1901-1
[3] A. Kapsalyamov, P. K. Jamwal, S. Hussain, and M. H. Ghayesh, “State of the art lower limb robotic exoskeletons for elderly assistance,” IEEE Access, vol. 7, pp. 95 075-95 086, 2019.
[4] H. Lee, P. W. Ferguson, and J. Rosen, “Chapter 11-lower limb exoskeleton systems—overview,” in Wearable Robotics, J. Rosen and P. W. Ferguson, Eds. Academic Press, 2020, pp. 207-229. [Online]. Available: https://www.sciencedirect.com/science/article/pii/B9780128146590000114
[5] S. A. Murray, R. J. Farris, M. Golfarb, C. Hartigan, C. Kandilakis, and D. Truex, “Fes coupled with a powered exoskeleton for cooperative muscle contribution in persons with paraplegia,” in 2018 40th Annual International Conference of the IEEE Engineering in Medicine and Biology Society (EMBC), 2018, pp. 2788-2792.
[6] P. Stegall, K. Winfree, D. Zanotto, and S. K. Agrawal, “Rehabilitation exoskeleton design: Exploring the effect of the anterior lunge degree of freedom,” IEEE Transactions on Robotics, vol. 29, no. 4, pp. 838-846, 2013.
[7] G. Zeilig, H. Weingarden, M. Zwecker, I. Dudkiewicz, A. Bloch, and A. Esquenazi, “Safety and tolerance of the Rewalk™ exoskeleton suit for ambulation by people with complete spinal cord injury: A pilot study,” The Journal of Spinal Cord Medicine, vol. 35, no. 2, pp. 96-101, 2012, pMID: 22333043. [Online]. Available: https://doi.org/10.1179/2045772312Y.0000000003
[8] “Eksonr bionics webpage,” https://eksobionics.com/eksonr/.
[9] “Cyberdyne webpage,” https://www.cyberdyne.jp/english/products/LowerLimb_medical.html.
[10] “Rewalk personal 6.0 exoskeleton for spinal cord injury”,” https://rewalk.com/rewalk-personal-3/.
[11] “Indego/ekso bionics webpage,” https://eksobionics.com/indego/.
[12] Y. M. Pirjade, D. R. Londhe, N. M. Patwardhan, A. U. Kotkar, T. P. Shelke, and S. Ohol, “Design and fabrication of a low-cost human body lower limb exoskeleton,” in 2020 6th International Conference on Mechatronics and Robotics Engineering (ICMRE), 2020, pp. 32-37.
[13] Y. Lee, S.-G. Roh, M. Lee, B. Choi, J. Lee, J. Kim, H. Choi, Y. Shim, and Y.-J. Kim, “A flexible exoskeleton for hip assistance,” 2017.
[14] K. Seo, J. Lee, and Y. J. Park, “Autonomous hip exoskeleton saves metabolic cost of walking uphill,” in 2017 International Conference on Rehabilitation Robotics (ICORR), July 2017, pp. 246-251.
[15] T. Zhang, M. Tran, and H. Huang, “Design and experimental verification of hip exoskeleton with balance capacities for walking assistance,” IEEE/ASME Transactions on Mechatronics, vol. 23, no. 1, pp. 274-285, 2018.
[16] A. Esquenazi, M. Talaty, and A. Jayaraman, “Powered exoskeletons for walking assistance in persons with central nervous system injuries: A narrative review,” PMR, vol. 9, no. 1, pp. 46-62, 2017. [Online]. Available: https://www.sciencedirect.com/science/article/pii/S1934148216308796
[17] Z. Li, K. Zhao, L. Zhang, X. Wu, T. Zhang, Q. Li, X. Li, and C.-Y. Su, “Human-in-the-loop control of a wearable lower limb exoskeleton for stable dynamic walking,” IEEE/ASME Transactions on Mechatronics, vol. 26, no. 5, pp. 2700-2711, 2021.
[18] M. Sharifi, V. Azimi, V. K. Mushahwar, and M. Tavakoli, “Impedance learning-based adaptive control for human-robot interaction,” IEEE Transactions on Control Systems Technology, vol. 30, no. 4, pp. 1345-1358, 2022.
[19] M. Sharifi, A. Zakerimanesh, J. K. Mehr, A. Torabi, V. K. Mushahwar, and M. Tavakoli, “Impedance variation and learning strategies in human-robot interaction,” IEEE Transactions on Cybernetics, vol. 52, no. 7, pp. 6462-6475, 2022.
[20] Q. Wei, Z. Li, K. Zhao, Y. Kang, and C.-Y. Su, “Synergy-based control of assistive lower-limb exoskeletons by skill transfer,” IEEE/ASME Transactions on Mechatronics, vol. 25, no. 2, pp. 705-715, 2020.
[21] W. Huo, S. Mohammed, J. C. Moreno, and Y. Amirat, “Lower limb wearable robots for assistance and rehabilitation: A state of the art,” IEEE Systems Journal, vol. 10, no. 3, pp. 1068-1081, 2016.
[22] K. Gui, H. Liu, and D. Zhang, “A practical and adaptive method to achieve emg-based torque estimation for a robotic exoskeleton,” IEEE/ASME Transactions on Mechatronics, vol. 24, no. 2, pp. 483-494, 2019.
[23] —, “A generalized framework to achieve coordinated admittance control for multi-joint lower limb robotic exoskeleton,” in 2017 International Conference on Rehabilitation Robotics (ICORR), 2017, pp. 228-233.
[24] S. Qiu, W. Guo, D. Caldwell, and F. Chen, “Exoskeleton online learning and estimation of human walking intention based on dynamical movement primitives,” IEEE Transactions on Cognitive and Developmental Systems, vol. 13, no. 1, pp. 67-79, 2021.
[25] X. Liu and Q. Wang, “Real-time locomotion mode recognition and assistive torque control for unilateral knee exoskeleton on different terrains,” IEEE/ASME Transactions on Mechatronics, vol. 25, no. 6, pp. 2722-2732, 2020.
[26] C.-F. Chen, Z.-J. Du, L. He, Y.-J. Shi, J.-Q. Wang, G.-Q. Xu, Y. Zhang, D.-M. Wu, and W. Dong, “Development and hybrid control of an electrically actuated lower limb exoskeleton for motion assistance,” IEEE Access, vol. 7, pp. 169 107-169 122, 2019.
[27] D. Zhang, Y. Ren, K. Gui, J. Jia, and W. Xu, “Cooperative control for a hybrid rehabilitation system combining functional electrical stimulation and robotic exoskeleton,” Frontiers in Neuroscience, vol. 11, 2017. [Online]. Available: https://www.frontiersin.org/articles/10.3389/fnins.2017.00725
[28] R. Huang, H. Cheng, J. Qiu, and J. Zhang, “Learning physical human-robot interaction with coupled cooperative primitives for a lower exoskeleton,” IEEE Transactions on Automation Science and Engineering, vol. 16, no. 4, pp. 1566-1574, 2019.
[29] R. Luo, S. Sun, X. Zhao, Y. Zhang, and Y. Tang, “Adaptive cpg-based impedance control for assistive lower limb exoskeleton,” in 2018 IEEE International Conference on Robotics and Biomimetics (ROBIO), 2018, pp. 685-690.
[30] C.-T. Pan, C.-C. Chang, Y.-S. Yang, C.-K. Yen, C.-C. Liu, C.-L. Lee, and Y.-L. Shiue, “Development a multi-loop modulation method on the servo drives for lower limb rehabilitation exoskeleton,” Mechatronics, vol. 68, p. 102360, 2020. [Online]. Available: https://www.sciencedirect.com/science/article/pii/S0957415820300404
[31] W. Huo, S. Mohammed, and Y. Amirat, “Impedance reduction control of a knee joint human-exoskeleton system,” IEEE Transactions on Control Systems Technology, vol. 27, no. 6, pp. 2541-2556, 2019.
[32] W. Huo, M. A. Alouane, Y. Amirat, and S. Mohammed, “Force control of sea-based exoskeletons for multimode human-robot interactions,” IEEE Transactions on Robotics, vol. 36, no. 2, pp. 570-577, 2020.
[33] M. Sharifi, J. K. Mehr, V. K. Mushahwar, and M. Tavakoli,

“Autonomous locomotion trajectory shaping and nonlinear control for lower limb exoskeletons,” IEEE/ASME Transactions on Mechatronics, vol. 27, no. 2, pp. 645-655, 2022.
[34] —, “Adaptive cpg-based gait planning with learning-based torque estimation and control for exoskeletons,” IEEE Robotics and Automation Letters, vol. 6, no. 4, pp. 8261-8268, 2021.
[35] “Ak series actuator manual,” https://store.tmotor.com/images/file/202208/251661393360838805.pdf.
[36] T. Lencioni, I. Carpinella, M. Rabuffetti, A. Marzegan, and M. Ferrarin, “Human kinematic, kinetic and emg data during different walking and stair ascending and descending tasks,” Scientific data, vol. 6, no. 1, p. 309, 2019.
[37] S. Nuzik, R. Lamb, A. VanSant, and S. Hirt, “Sit-to-stand movement pattern: a kinematic study,” Physical therapy, vol. 66, no. 11, pp. 1708-1713, 1986.

### C. Knee Exoskeleton

### C1. BACKGROUND/Knee Exoskeleton

### 1 Introduction

Studies have shown that there is a steadily increasing gap between the number of people in need of physical rehabilitation and the healthcare professionals that can provide it. By 2030 almost 48 out of the 50 states in the US will have a shortage of physical therapists [1]. According to the Centers for Disease Control and Prevention (CDC), 13.7% of adults have a mobility disability or have serious difficulty walking or climbing stairs [2]. This growing problem has pushed the biomedical device industry to begin developing soft robotic exoskeletons that prevent workplace injury and help assist physical therapists during rehabilitation sessions [3,4].

In past years there have been significant advances in using exoskeletons to aid in the rehabilitation of the physically impaired [5]. Originally robotic exoskeletons were far too expensive, heavy, and cumbersome to be used effectively. Engineers are now focused on developing exoskeletons that are comfortable to wear and aim to improve human-robot interaction [6]. Innovative soft and wearable exoskeletons are designed to provide a more unobtrusive and comfortable interface between the user and the robot [7,8]. In place of stiff metal rods and heavy motor-powered actuators mounted throughout the exoskeleton, soft exoskeletons use lightweight 3D printed materials, soft interfaces like cloth, textile, and fabric, and alternate methods of actuation like a cable-pulley system to make wearing and moving in an exoskeleton more ergonomic and user friendly. Wearable robotic exoskeletons are still in their infancy, and future development involves improving adaptive control, integrating different techniques to actuate the muscles and limbs, and developing ways of using lightweight yet strong materials to reduce total weight.

1.1 Limitations of Rigid Exoskeleton Design. The first developed exoskeletons had rigid structures, made of links that were set parallel to the limb. Most designs prioritized the strength of materials and powerful actuators so that the exoskeleton could be used to lift heavy loads and increase the productivity of factory or warehouse workers. While these rigid designs worked for industrial applications, they did not translate well for the biomedical industry. Rigid links cause discomfort and joint injury due to movement constraints [9]. The weight of the links as well as the powerful actuators required to move them made the exoskeletons very heavy and hard to maneuver [10,11]. While a rigid design can achieve better results as a more accurate and controllable robot it sacrifices comfortability and ergonomics in the process [12]. The rigid design also requires many complex and heavy actuators which are very expensive and drive up the cost of the exoskeleton. Such factors make the rigid design insufficient for the application of exoskeletons in physical rehabilitation. Soft designs or a hybrid between the two design philosophies are more commonly used when designing an exoskeleton today.

1.2 Emerging Soft Exoskeleton Designs. Soft exoskeletons are made of components that are ergonomic, lightweight, and comfortable. Instead of rigid metal links and heavy actuators, soft design takes advantage of cloth straps as the interface between the limbs and the robot. Soft designs also take advantage of pulleys or pneumatics as alternatives to using heavy motors for actuation [13,14]. Using cloth fabric makes wearing an exoskeleton easier for longer periods, and makes the overall robot lighter and more maneuverable. By using alternative methods of actuation like Bowden cables and pneumatics, the weight of the motors can be relocated from the joints of the limb to the waist allowing for most of the weight to be redistributed to the center of mass. Previous studies show the benefits and drawbacks of using these alternative types of actuation.

Veneman et al.[15] designed a Lower Extremity Powered Exoskeleton (LOPES) that used a Bowden cable-based system intended to be used as torque actuators. The goal of their project was to create a system that would allow the heavy electromotor to be removed from the frame of the exoskeleton and instead be mounted in a stationary position while a patient undergoes gait rehabilitation on a treadmill. These cables would act as or simulate the rotation joints in the knee and hip creating both flexion and extension forces which would translate into the bending or extending of the knee [15]. The results of the project confirmed that the LOPES bowed cable system was a sufficiently lightweight, adjustable, and powerful torque actuator.

Another exoskeleton that was reviewed was the Exo-Muscle developed by Zhang et al. [16] This exoskeleton was designed to benefit from the stability of a more rigid design and flexibility from a newer user-friendly design while still being able to provide assistive torque at the knee joint [16]. A novel semi-rigid knee chain would provide rigidity when standing but also allow the exoskeleton to bend with the knee. Flexible belts, cables, and lightweight actuators were used to power the chain making the Exo-muscle a very lightweight and user-friendly exoskeleton.

1.3 Improving Human-Robot Interaction. As robots become more integrated with medical applications it has become very evident that the interaction between machines and humans must be considered when designing a medical robot [17,18]. For medical robots to be effective in rehabilitating patients they must assist in the physical aspect of rehabilitation and the cognitive aspect as well. Aspects involving language, perception, motivation, attention, and memory are just as important when measuring the effectiveness of the physical rehabilitation of the patient [12]. Cespedes et al. implemented a socially assistive robot called NAO to help aid physical therapists by monitoring a patient's heart rate and posture while also providing and collecting feedback to and from the patient during gait rehabilitation sessions. Using the NAO robot resulted in better back posture and more active engagement from the patient while the physical therapist focused mostly on correcting the gait of the lower limbs [12]. Assistive NAO robots reveal the importance of designing around Human-Robot Interaction and that positive interactions between robots and humans can improve the effectiveness of physical therapy.

### C2. BRIEF DESCRIPTION OF THE DRAWINGS/Knee Exoskeleton

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

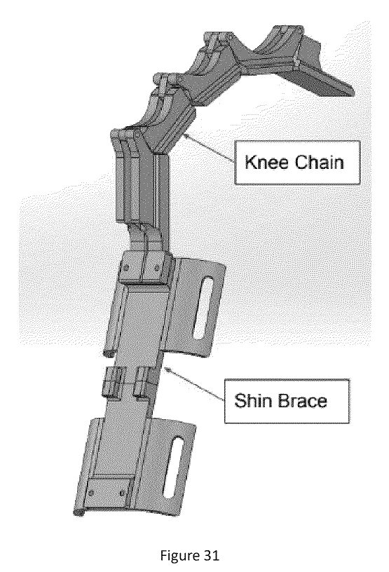

FIG. 31 is an illustrative drawing showing a perspective view of a knee exoskeleton in accordance with some embodiments.

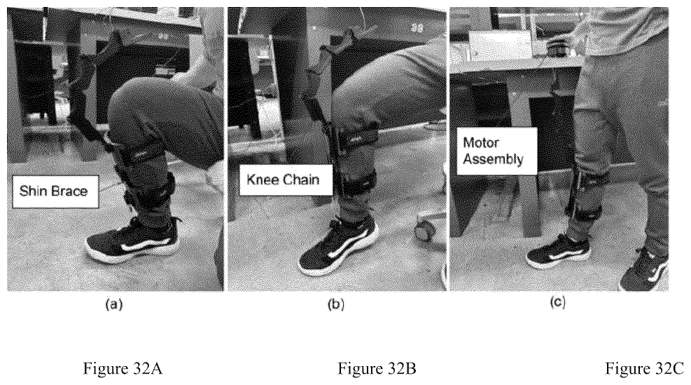

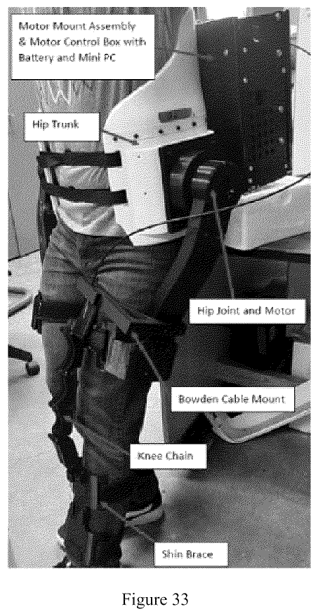

FIG. 32A is an illustrative drawing showing the example knee exoskeleton of FIG. 31 mounted to a user's leg with the knee chain fully compressed.

FIG. 32B is an illustrative drawing showing the example knee exoskeleton of FIG. 31 mounted to a user's leg with the knee chain partially compressed.

FIG. 32C is an illustrative drawing showing the example knee exoskeleton of FIG. 31 mounted to a user's leg with the knee chain fully extended.

FIG. 33 is an illustrative drawing showing an example knee exoskeleton and hip exoskeleton mounted to a user.

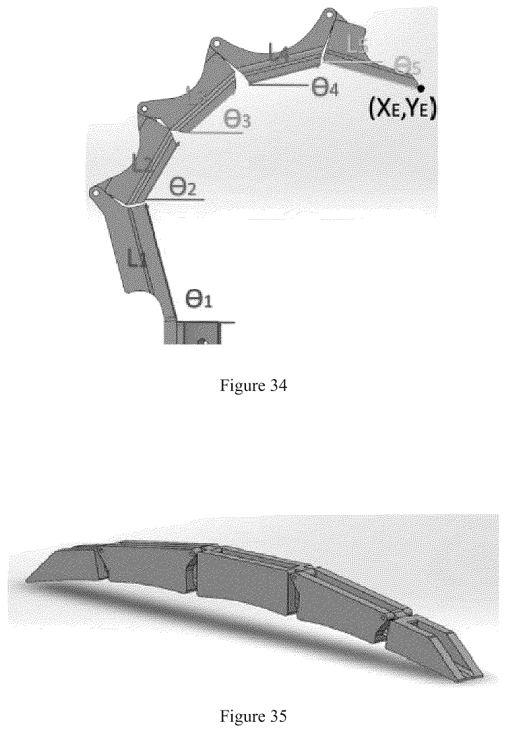

FIG. 34 is an illustrative drawing showing a side view of an example five-link knee chain in a fully compressed state of curvature.

FIG. 35 is an illustrative drawing showing perspective view of another example five-link knee chain in a fully extended state of curvature.

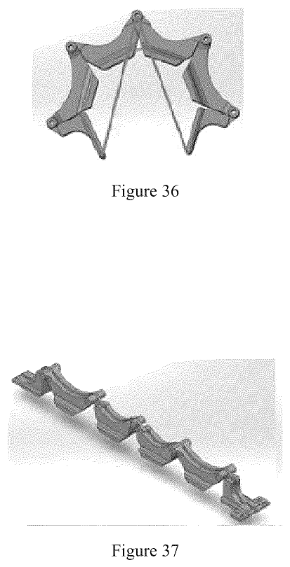

FIG. 36 is an illustrative drawing showing a perspective view of an example six-link knee chain in a fully compressed state of curvature.

FIG. 37 is an illustrative drawing showing perspective view of the example six-link knee chain of FIG. 36 in a fully extended state of curvature.

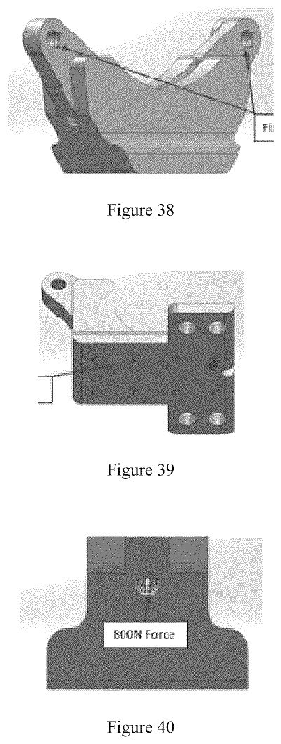

FIG. 38 is an example side perspective view of an inner link of a knee chain in accordance with some embodiments of FIGS. 34, 36, 37.

FIG. 39 is an example bottom perspective view of end link of a knee chain in accordance with some embodiments of FIGS. 33, 35, 36.

FIG. 40 is an example bottom view of end link of a knee chain in accordance with some embodiments of FIGS. 33, 35, 36.

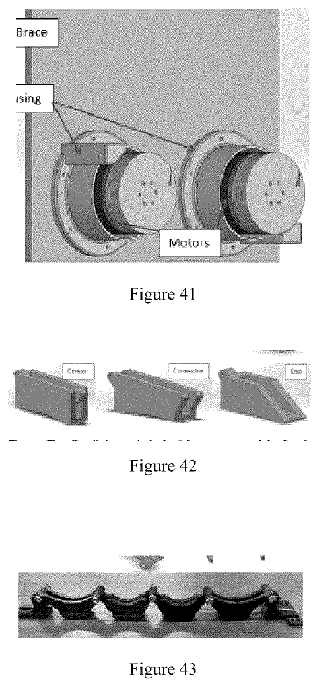

FIG. 41 is an illustrative drawing showing two pulley motors mounted to a base support structure that can be worn upon a user's back.

FIG. 42 is an illustrative drawing showing an example individual links of the example five-link geometry of the knee chain of FIG. 35.

FIG. 43 is an illustrative fabrication of the six-link knee chain design, total length of 15 in and bend angle of 30 degrees

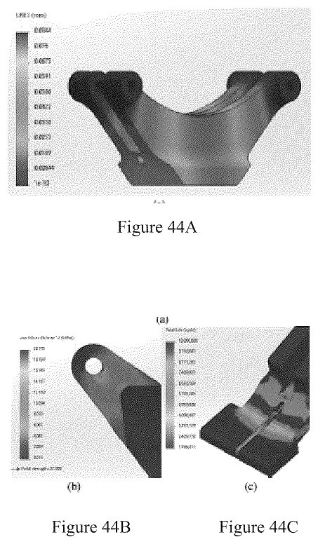

FIGS. 44A-44B are illustrative drawings showing results of an FEA study that showed a maximum displacement of 0.01 mm (a) and a maximum stress of 20 MPa (b) for the Semi-Rigid Knee Chain Links under the maximum 800 N load. Fatigue analysis shows that the Knee Chain can withstand 1.5×106 cycles (c)

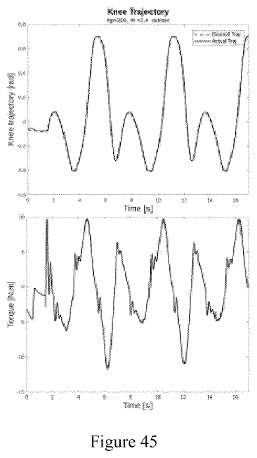

FIG. 45 shows graphs showing experimental results of the slow walk test (ω=1.4 rad/s): The maximum torque observed was 12 Nm.

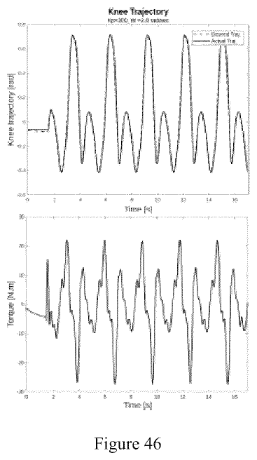

FIG. 46 shows graphs showing experimental results of the fast walk test (ω)=2.8 rad/s). Maximum torque observed was 29 Nm.

### C3. DETAILED DESCRIPTION/Knee Exoskeleton

### Mechanical Overview of Knee Exoskeleton

FIG. 31 is an illustrative drawing showing a perspective view of a knee exoskeleton in accordance with some embodiments. FIGS. 32A-32C show the example knee exoskeleton of FIG. 31 mounted to a user's leg. The knee exoskeleton includes a knee chain, a shin brace, and a Bowden cable (not shown), and a motor actuator (not shown) configured to turn a pulley to tighten and loosen the Bowden cable. It is noted that as used herein, the term “proximal” refers to locations closer to the patient's upper torso and the term “distal” refers to locations farther from the patient's upper torso. The knee chain includes multiple links. An example knee chain in FIGS. 31-33 has five links. An alternative example knee chain shown in FIGS. 36-37 has six links. A distal link in the knee chain is fixedly secured to a proximal portion of the shin brace. Each link of the example knee chain defines a respective longitudinally through-hole oriented longitudinally relative to the overall knee chain. The through-holes are arranged such that a portion of a Bowden cable can be routed through each of the links of the knee chain to extend between the proximal link in the knee chain to the distal link in the knee chain. A distal tip portion of the Bowden cable can be secured to a portion of the shin brace. The shin brace includes a longitudinal bar that is integrally connected to a proximal outer partial cuff and a proximal inner partial cuff, both of which are inwardly arched to reach partially around and support a frontal portion of a user's leg closer to the user's knee. The shin brace longitudinal bar also is integrally connected to a distal outer partial cuff and a distal inner partial cuff, both of which are inwardly arched to wrap partially around and support a frontal portion of the user's leg closer to the user's foot. The proximal outer partial cuff and the proximal inner partial cuff each define a respective slot to receive a fabric fastener (not shown) to reach around the back of the user's leg to secure them to the user's leg. The distal outer partial cuff and the distal inner partial cuff each define a respective lower slot to receive a fabric fastener (not shown) to reach around the back of the user's leg to secure them to the user's leg.

FIG. 32A is an illustrative drawing showing the example knee exoskeleton of FIG. 31 mounted to a user's leg with the knee chain fully compressed. FIG. 32B is an illustrative drawing showing the example knee exoskeleton of FIG. 31 mounted to a user's leg with the knee chain partially compressed. FIG. 32C is an illustrative drawing showing the example knee exoskeleton of FIG. 31 mounted to a user's leg with the knee chain fully extended. The motor actuator turns a pulley, shown in FIG. 41 to adjust length of the Bowden cable within the knee chain to thereby determine curvature of the knee chain. In the fully compressed state of curvature of the knee chain shown in FIG. 32A, a least length of Bowden cable extends within the knee chain. In the fully extended state of curvature of the knee chain, shown in FIG. 32C, a maximum length of the Bowden cable extends within the knee chain. In the partially compressed state of curvature of the knee chain shown in FIG. 32B, a length of Bowden cable that measures between the least and maximum extends within the knee chain. As shown in FIG. 32A, the user's knee is most extremely bent when the knee chain is in the fully compressed state of curvature. As shown in FIG. 32C, the user's knee extends straight and is unbent when the knee chain is in the fully extended state of curvature. As shown in FIG. 32B, the user's knee is partially bent when the knee chain is in the partially compressed state of curvature. Thus, it will be appreciated that the knee chain converts the tension of the Bowden cable into torque used to bend and extend the user's knee.

FIG. 33 is an illustrative drawing showing an example knee exoskeleton and hip exoskeleton mounted to a user. A distal Bowden cable mount that is attached to an upper portion of a user's thigh secures a distal end of a cable housing through which the Bowden cable passes. A proximal Bowden cable mount (not shown) located near the pulley motor secures one end of a cable housing through which the Bowden cable passes.

FIG. 34 is an illustrative drawing showing a side view of an example five-link knee chain in a fully compressed state of curvature. FIG. 35 is an illustrative drawing showing perspective view of another example five-link knee chain in a fully extended state of curvature. FIG. 36 is an illustrative drawing showing a perspective view of an example six-link knee chain in a fully compressed state of curvature. FIG. 37 is an illustrative drawing showing perspective view of the example six-link knee chain of FIG. 36 in a fully extended state of curvature.

FIG. 38 is an example side perspective view of an inner link of a knee chain in accordance with some embodiments of FIGS. 34, 36, 37. FIG. 39 is an example bottom perspective view of end link of a knee chain in accordance with some embodiments of FIGS. 34, 36, 37. FIG. 40 is an example bottom view of end link of a knee chain in accordance with some embodiments of FIGS. 34, 36, 37. The example inner link shown in FIG. 24 includes two opposite extending connector tongue each with a respective hole to receive link connector pins (not shown), first and second opposite-facing angled stop surfaces, and a hole to receive a Bowden cable. The example end link shown in FIG. 39 includes a connector tongue with a hole to receive a link connector pin (not shown), and a stop surface. A Bowden cable through-hole is not visible in the end link. A force is shown imparted to a bottom surface of the end link shown in FIG. 40.

Referring again to FIGS. 32A-32B, throughout the range of curvature of the knee chain, the knee chain is free floating over the user's knee. That is, during a normal clinical event, the knee chain does not touch the user's knee at any state of curvature. Number, angle, and spacing of links in the chain are selected to compose a knee chain in which adjustment of Bowden cable length within the knee chain can be used to selectively cause bending and straightening a user's knee without the knee chain ever contacting the user's knee. For example, link length, space between stop surfaces of adjacent links, and relative angles of stop surfaces of adjacent links are selected to compose such a knee chain.

FIG. 41 is an illustrative drawing showing two pulley motors mounted to a base support structure that can be worn upon a user's back. In practice, a separate knee exoskeleton can be mounted to each of a user's legs. A respective pulley is operatively coupled to each respective motor such that each motor can impart rotational motion to the pulley coupled to it, which in turn, adjusts tension imparted to a Bowden cable having a distal end attached to one of the two knee exoskeletons. Each respective motor is associated with a respective proximal Bowden cable mount (only one visible) that is attached to the base support structure and secures a proximal end of a Bowden cable housing through which a respective Bowden cable controlled by the respective motor passes.

### 1.4 Research Aim.

Accordingly, this research work is aimed to develop a lightweight, user-friendly, and comfortable exoskeleton for the knee joint with a high torque capacity to resolve the drawbacks of commercially available rigid exoskeletons. This exoskeleton will also improve on the ideas introduced by novel soft exoskeletons like LOPES and Exo-Muscle by further reducing the total weight and integrating into a completely wearable hip and knee exoskeleton system.

In this paper, the design and fabrication of this lightweight and wearable semi-rigid robotic knee chain exoskeleton are described. The main components of this knee exoskeleton are composed of a lightweight semi-rigid knee chain 3D printed from Polyethylene Terephthalate Glycol (PETG), a flexible shin brace 3D printed from thermoplastic polyurethane (TPU), and a plate fabricated from carbon fiber sheets. The knee chain has five segments to make a curve around the knee joint and is actuated by a Bowden cable and pulley assembly powered by a high-torque DC motor (AK80-64 model from T-Motor). The geometry of the semi-rigid knee chain was designed using SOLIDWORKS topology optimization and FEA to achieve an appropriate balance between weight and strength. FEA studies conducted on the knee chain show that the chain has at least a 2.4 factor of safety while under the expected maximum knee torque of 50 Nm at a 30-degree knee flexion angle. The five-link design also allows the knee chain to be very flexible, with a maximum flexion angle of 145 degrees. The total weight of the combined knee chain and shin brace assembly weighs 2.5 lbs. The DC motor actuators are mounted on the carbon fiber plate to minimize the inertia of moving parts and allow the user to move with the robot as one unit. This assistive robotic system is controlled in real-time by a mini-PC, a microcontroller, and intermediate boards. Soft, flexible, and wearable materials are integrated at the points of contact between the wearer and machine to achieve comfortable human-robot interaction while being able to provide support in flexing and extending the knee joint.

### 2 Knee Chain Exoskeleton Layout and Material Selection

The layout of the actuators, Bowden cables, and points of contact of the exoskeleton was designed to be unobtrusive and convenient for the user. The objective was to place components of the exoskeleton where they could not obstruct basic movements like sitting down, squatting, or bending over. By using Bowden Cables as the method of actuation, the heavy motor actuators can be mounted in other places instead of directly on the knee. The placement of the hip exoskeleton also had to be taken into consideration when designing the layout. Components to house the Bowden cable were designed to integrate into places where the knee and hip systems overlapped.

The exoskeleton is designed to integrate 3D printed parts, soft wearable materials, and metal Bowden cables into one system. The 3D-printed parts are made of two plastics. The first filament material is a thermoplastic polyester called PETG (Polyethylene terephthalate glycol). This plastic was chosen for its high tensile strength and lightweight and is used for the components of the exoskeleton that require rigidity and durability. A flexible and elastic filament material called TPU (thermoplastic polyurethane) was chosen for components that would be in direct contact with the user's anatomy to promote a better robot-human interface.

Two motor actuators are required to power the exoskeleton system with a required maximum torque rating of at least 50 Nm. Different motors were compared and ranked based on their achievable maximum and continuous torque ratings, and total weight. The T-motor AK80-64 was chosen due to its relatively low weight of 0.8 kg and high torque ratings of 48 Nm continuous torque and 120 Nm max torque. Additionally, the AK80-64 does not require a gear train to achieve high torque, making it more compact than most other options.

### 3 Design of the Semi-Rigid Knee Chain

The semi-rigid knee chain displayed in FIG. 1) is the main component of the exoskeleton and is composed of multiple rigid links that connect to form a chain. A channel runs through the length of each link which will allow a Bowden cable to thread through the entire chain. When the cable is pulled taught the chain will bend and compress and when the cable is released the chain will return to its straight position.

The main challenge while designing the Semi-rigid knee chain was finding the correct ratio between the length and bending angle of each link that would allow the chain to curve around the knee. Equation (1) and FIG. 32A, shows the relationship between the link length (lₙ), link angle (θₙ), and end points of the chain (X_{E}, Y_{E}). The design evolved over four iterations, where different aspects of the links were changed throughout each iteration to achieve a better length, bend angle, or shape. Other tools like topology optimization and finite element analysis also influenced the design of the knee chain to achieve a lightweight and ergonomic

$${Y}_{E} = {\sum }_{n = 1}^{5} {l}_{n} cos ( {θ}_{n} ) + {l}_{n + 1} cos ( {θ}_{n} + {θ}_{n + 1} ) + … \qquad ( 1 )$$

$${X}_{E} = {\sum }_{n = 1}^{5} {l}_{n} sin ( {θ}_{n} ) + {l}_{n + 1} sin ( {θ}_{n} + {θ}_{n + 1} ) + …$$

Another influencing factor and challenge when designing the knee chain was how it would be fabricated. Each version of the chain was completely 3D printed with a Fused Deposition Modeling (FDM) Printer. Factors like print orientation, percent infill, and the limited print volume would have significant influences when designing the chain and other 3D-printed parts. In order to maximize strength, the chain links were printed at a 60% infill and oriented so that the layer lines were parallel to the expected applied force. Larger parts that could not fit inside the printer's print volume had to be redesigned as multiple pieces that had to be assembled together.

3.1 First Five-Segment Design and Topology Optimization. The first draft of the semi-rigid chain was originally only five links long shown in FIG. 35. The complete chain assembly was made of three different types of knee links, a center link, two connector links, and two end links as shown in FIG. 42.

This preliminary design gave us the basic geometry of the different links of the chain and would allow us to perform basic FEA simulations and a topology study to further refine and optimize the shape of the links. The FEA results proved that the links would easily withstand the full force of the motor pulling the Bowden.

cable and that extra material could be removed. The constraints were to preserve the rigidity and strength at key areas of the links, like the bases and connection points while removing non-essential material and reducing the mass by an additional 40%-50%. The results were that the widths of the links could be reduced and most of the material between the connection holes could be removed while still maximizing the stiffness of each link. A total of 200 g was taken of the final weight of the entire knee chain assembly.

3.2 Six Link Designs. The second and third iterations of the chain changed the design to have six links instead of five. The original five-link design was found to collide with the knee and could not achieve an acute enough angle when squatting. To achieve better angles additional material had to be removed from the links to prevent them from colliding with each other when the chain was fully compressed. This was done by splitting the center link into two separate links and reducing the length of the bases of each link. Two chains were designed and fabricated, the first six-link chain measured 18 inches long fully extended and had a bend angle of 85 degrees. The second six-link chain is shown in FIG. 43 and was 3 inches shorter than the original, measured at 15 inches but could achieve a better bend angle of 30 degrees. Basic stress tests of the chains were also performed to see if they would be able to withstand high bending stresses. Both chains were manually bent into their compressed positions to see if they would break. These tests resulted in some deformation and fracturing at the pin-hole connection points which would be addressed in the next iteration of the knee chain.

3.3 Improved Five Link Design. After performing some tests with the new six-link designs, it was found that the chain still came into contact with the knee in certain positions and that there were weaknesses in the joint connections of the links. The space in between each link for the six-link designs allowed for greater bending angles but would cause the chain to touch the knee when compressed. To fix this, we had to find a good balance between spacing and bend angle, as well as find a way to mount the chain farther away from the shin. The first change was to combine the end link and connector link and add some extra material to the corners of the center links. This change effectively removed some space in between each link to allow the chain to curve around the bend of the knee but left enough space to allow a sufficient enough angle so that the knee had room to bend. The second change was to add a 35-degree angle. This created more space between the knee and chain without sacrificing more space between each link. To address the fracturing and deformation at the pin-hole joints An additional ⅓ inch thickness was added to each link to make the chain more robust.

3.4 Design of the Auxiliary Exoskeleton Components. Two other assemblies were also designed and fabricated for the exoskeleton. A soft and user-friendly shin brace, designed to anchor the knee chain to the user's leg, and a motor actuator housing and assembly, designed to be mounted on the back of the user onto a carbon fiber layered foam board plate. These parts were also designed to integrate and combine with the hip and ankle exoskeleton systems.

The shin brace was designed to be as user-friendly as possible due to it being the main attachment point of the exoskeleton to the user. The brace is fastened to the leg using soft neoprene straps which are threaded through built-in slots shown in shown in shin brace of FIG. 31. The end knee link will be attached at the top of the brace while the Bowden cable continues down to the bottom end where it will be fastened to the cable housing. Additional Bowden cable housings will also be integrated into other parts of the total exoskeleton system to route the cable up the leg and to the back, where the motors will be mounted.

The motor assembly is made of three components, the pulley, the motor assembly housing, and an AK80-64 Motor Actuator. The head of the Bowden cable is press-fit into a pulley that is installed directly onto the output of the motor. The motor, pulley, and cable are then placed into a motor assembly housing that is mounted onto a carbon fiber plate. This carbon fiber plate will be used to hold all the motors required to move the knee and ankle systems of the exoskeleton, as well as the electronics and battery required to control them. The user would then wear the plate on their back, making the entire system portable. FIG. 6(b) shows two motor actuator assemblies mounted on the carbon fiber plate.

### 4 Finite Element Analysis of the Semi-Rigid Knee Chain

FEA simulations were conducted on all three link types, end, connector, and center links. Maximum applied loads were calculated by using the torque Eq. (2). Estimated values of applied torque and torsion arm length were compared with the experimental data collected by Zhang et. al. during the development of the Exo-muscle exoskeleton [16]. The maximum torque applied by the motors was observed to be between 45-50 Nm, Fig. shows that the torque arm is at its shortest of 0.065 meters at a 30 degrees knee flexion angle. This results in a maximum applied force of 770 N just as the knee begins to bend.

$$τ = r F sin θ ⇔ F = \frac{τ}{r sin θ} \qquad ( 2 )$$

FIG. 7 shows the simulation boundary condition setup, where the connector pin holes were treated as fixed geometry, and an 800 N force was applied inside the channel that holds the Bowden cable for all three links. The base of the end link was also fixed because its base will be mounted onto another component. The connector and center links are considered free-floating parts and will only be connected via the connector pin holes.

Certain assumptions were required to be made for these simulations due to the unpredictability of how 3D-printed components behave under different loads. Material strength can vary depending on factors like infill percentage, layer height, and print orientation [19]. To be as conservative as possible the weaker values of the material properties of the thermoplastic filament, PETG were used for yield and tensile strength and were paired with the highest expected loads possible to ensure sufficient factor of safety on the printed components.

4.1 Semi-Rigid Knee Chain FEA Results. The first two FEA studies were done on the center and connector links. FIG. 44A displays the maximum displacement under an 800 N load. The highest maximum displacement was observed on the connector link which was only 0.01 mm located on the inside of the channel. The areas expected to see the highest Von Mises stress are shown in FIG. 44B. Maximum stresses are expected to be inside the Bowden cable channel and connector pin holes for both links. The highest observed Von Mises stresses were 20 MPa and 17 MPa for the center and connector links respectively.

The next study conducted was on the end link. The displacement and Von Mises stress results which were considerably lower than the other links due to the base of this link being fixed onto the shin brace. Maximum displacement was in the channel of the link, measured at a value of 0.01 mm. High stress was concentrated primarily inside the Bowden cable channel with the maximum stress observed at only 7 MPa. The end link had a factor of safety of 3. These results show that all three links would not fail and should be safe even in the worst-case loading scenarios.

A fatigue analysis was also performed on all three links with the load of 800 N applied on the Bowden cable channel for a total of 1×106 cycles. Results of this fatigue analysis showed that all FIG. 44C features the end link which would be the first component to fail. The point of failure is located at the corner of the 15-degree incline in the end link.

### 5 Fabrication of the Exoskeleton

All components of the exoskeleton were fabricated using FDM 3D Printers. The links of the knee chain, the motor housings, and the Bowden cable housings were printed in Polyethylene Terephthalate Glycol (PETG), a type of thermoplastic that is strong, durable, and heat resistant. The links were printed with a 50% infill which provides a good balance between the amount of material used and maximizing strength. Each link measures from 2-5 inches in length and is 1.5 inches wide. Screws and nuts were used to connect the links and attach the knee chain to the shin brace.

The shin brace was printed using Thermoplastic Polyurethane (TPU), a soft and flexible thermoplastic that gives the 3D-printed part some elasticity. This material will allow the shin brace to better shape itself around the user's leg regardless of shape and size. This component was printed at a lower 20% infill to create more empty space within the part, allowing for even more flexibility. The knee chain is installed to the top half of the brace while housing for the tail end of the Bowden cable is installed at the bottom. Neoprene straps are threaded through the slots of the shin brace which attach the entire brace and knee chain to the user.

The carbon fiber plate is made of a 24×18 inch and ⅜ inch thick Vinyl Foam Board core layered with 2×2 Carbon Fiber Fabric Twill on both sides. The plate was fabricated by using a wet layup process, where sheets of carbon fiber twill were layered onto the foam board and saturated with laminating epoxy. A 100:27 part epoxy to-hardener mixture was used as the liquid resin for the wet layup. The layup schedule is featured in the figure below, where the first layer is a liquid PVA release which will make removing the plate from the flat work surface easier. The rest of the layers were composed of eight total layers of carbon fiber and epoxy, four on each side of the foam core.

The plate is then vacuum-sealed and air-dried for 24 hours. After completing the wet layup process, the plate was cut into two 12×18-inch halves. Holes were drilled on both plates to be able to attach them to the back of a hip exoskeleton and mount the motor housings. The first plate would be installed into the back of a hip exoskeleton and serve as the back wall of the electronics box. The second plate would hold the motors and would also be used as the door of the electronics box.

### 6 Experimental Results and Observations

The knee chain was observed at different compressed and extended positions to see how it would behave. The original five-link and six-link iterations of the chain were tested by manually positioning the chain over the knee and moving it into different positions. These positions would mimic how the chain would behave when squatting and the chain fully compressed, sitting with the chain in a half-bent position, and standing and the chain in a fully extended position. These initial tests revealed the different angles and positions where the chain could come into direct contact with the knee. Changes and re-designs were made to the geometry and spacing of links, as well as the total number of links to make the chain free floating over the knee. Once the chain's design was finalized tests were performed with the knee chain connected to a motor actuator.

A preliminary motor control test was performed by connecting the AK80-64 motor to a laptop by using an R-link USB to the serial port module and then actuated with CubeMars motor control software. The squat, sit, and stand positions were mapped onto different positions of the motor. The exoskeleton was then cycled between the three different positions at a speed of 1.00 rad/s. The chain was able to compress and lengthen without inhibiting the user from wearing the exoskeleton or making contact with the knee. FIG. 9 features the three different test positions of the exoskeleton.

The final set of tests performed were functional tests used to plot data of the desired and actual positional trajectories of the knee during a walking cycle. The desired walking trajectory (qdesired) for the knee joint, defined in Eq. (3), was obtained from experiments done by Lencioni et al. [20]. Where a₀, aₖ, and bₖ are coefficients of the Fourier series and θ(t) is the speed in radians per second of the oscillatory motion.

$${q ( t )}_{desired} = {a}_{0} + {\sum }_{k = 1}^{N} [ {a}_{k} cos ( k θ ( t ) ) + {b}_{k} sin ( k θ ( t ) ) ] \qquad ( 3 )$$

The knee chain exoskeleton was combined with the larger hip exoskeleton system shown in FIG. 33. The motor was mounted on the back of the motor control box where the Bowden cable was pulled and released by a pulley. The cable was routed from the back plate down through the hip exoskeleton and into the knee using cable mounts and housings.

The two speeds that tests were performed at were a slow speed (ω=1.4 rad/s) and fast speed (ω=2.8 rad/s). Both speeds were tested at a stationary position where the user would be seated and the leg would be allowed to move independently from the rest of the body, and during a walking cycle where the user took multiple steps. Once the desired and actual trajectories were plotted we used equation 4, which is the percent error between the desired (q_{desired}) and actual (q_{actual}) trajectories multiplied by the gains of the proportional-derivative controller (kₚ and k_{d}), to obtain the applied torque of the motors (τₘ), shown in FIG. 45 and FIG. 46.

$${τ}_{m} = {k}_{p} ( {q ( t )}_{desired} - {q ( t )}_{actual} ) + {k}_{d} ( {q ( t )}_{desired} - {q ( t )}_{actual} ) \qquad ( 4 )$$

### C4. REFERENCES/Knee Exoskeleton

[1] Zimbelman, J. L., Juraschek, S. P., Zhang, X., and Lin, V. W., 2010, “Physical Therapy Workforce in the United States: Forecasting Nationwide Shortages,” PM&R, 2.
[2] CDC, 2022, “Disability and Health Data System (DHDS),” Centers for Disease Control and Prevention, See also URL http://dhds.cdc.gov.
[3] Shi, D., Zhang, W., Zhang, W., and Ding, X., 2019, “A Review on Lower Limb Rehabilitation Exoskeleton Robots,” Chinese Journal of Mechanical Engineering, 32(74).
[4] Li, N., Yang, T., Yu, P., Chang, J., Zhao, L., Zhao, X., Elhajj, I. H., Xi, N., and Liu, L., 2018, “Bio-inspired upper limb soft exoskeleton to reduce stroke-induced complications,” Bioinspiration Biomimetics, 13(6).
[5] Kim, T., Jeong, M., and Kong, K., 2022, “Bioinspired Knee Joint of a Lower-Limb Exoskeleton for Misalignment Reduction,” IEEE/ASME Transactions on Mechatronics, 27(3), pp. 1223-1232.
[6] Xiloyannis, M., Alicea, R., Georgarakis, A.-M., Haufe, F. L., Wolf, P., Masia, L., and Riener, R., 2022, “Soft Robotic Suits: State of the Art, Core Technologies, and Open Challenges,” IEEE Transactions on Robotics, 38(3), pp. 1343-1362.
[7] Oghogho, M., Sharifi, M., Vukadin, M., Chin, C., Mushahwar, V. K., and Tavakoli, M., 2022, “Deep Reinforcement Learning for EMG-based Control of Assistance Level in Upper-limb Exoskeletons,” 2022 International Symposium on Medical Robotics (ISMR), pp. 1-7.
[8] Chen, T., Casas, R., and Lum, P. S., 2019, “An Elbow Exoskeleton for Upper Limb Rehabilitation With Series Elastic Actuator and Cable-Driven Differential,” IEEE Transactions on Robotics, 35(6), pp. 1464-1474.
[9] Wei, W., Qu, Z., Wang, W., Zhang, P., and Hao, F., 2018, “Design on the Bowden cable-driven upper limb soft exoskeleton,” Applied Bionics and Biomechanics, 2018.
[10] Sharifi, M., Mehr, J. K., Mushahwar, V. K., and Tavakoli, M., 2021, “Adaptive CPG-Based Gait Planning With Learning-Based Torque Estimation and Control for Exoskeletons,” IEEE Robotics and Automation Letters, 6(4), pp. 8261-8268.
[11] Sharifi, M., Mehr, J. K., Mushahwar, V. K., and Tavakoli, M., 2022, “Autonomous Locomotion Trajectory Shaping and Nonlinear Control for Lower Limb Exoskeletons,” IEEE/ASME Transactions on Mechatronics, 27(2), pp. 645-655.
[12] Céspedes, N., Múnera, M., Gómez, C., and Cifuentes, C. A., 2020, “Social Human-Robot Interaction for Gait Rehabilitation,” IEEE Transactions on Neural Systems and Rehabilitation Engineering, 28(6), pp. 1299-1307.
[13] Robertson, M., Sadeghi, H., Florez Marin, J., and Paik, J., 2016, “Soft Pneumatic Actuator Fascicles for High Force and Reliability,” Soft Robotics, 4.
[14] Henderson, G. C. and Ueda, J., 2012, “Pneumatically-powered robotic exoskeleton to exercise specific lower extremity muscle groups in humans,” 2012 4th IEEE RAS EMBS International Conference on Biomedical Robotics and Biomechatronics (BioRob), pp. 1506-1511, doi: 10.1109/BioRob.2012.6290904.
[15] Veneman, J., Ekkelenkamp, R., Kruidhof, R., van der Helm, F., and van der Kooij, H., 2005, “Design of a series elastic- and Bowden cable-based actuation system for use as torque-actuator in exoskeleton-type training,” 9th International Conference on Rehabilitation Robotics, 2005. ICORR 2005., pp. 496-499, doi: 10.1109/ICORR.2005.1501150.
[16] Zhang, Y., Ajoudani, A., and Tsagarakis, N. G., 2021, “Exo-Muscle: A Semi-Rigid Assistive Device for the Knee,” IEEE Robotics and Automation Letters, 6(4), pp. 8514-8521.
[17] Sheridan, T., 2016, “Human-Robot Interaction: Status and Challenges,” Human factors, 58.
[18] Kosuge, K. and Hirata, Y., 2004, “Human-Robot Interaction,” 2004 IEEE International Conference on Robotics and Biomimetics, pp. 8-11, doi: 10.1109/ROBIO. 2004.1521743.
[19] Abbot, D., Kallon, D., Anghel, C., and Dube, P., 2019, “Finite Element Analysis of 3D Printed Model via Compression Tests,” Procedia Manufacturing, 35, pp. 164-173.
[20] Lencioni, T., Carpinella, I., Rabuffetti, M., Marzegan, A., and Ferrarin, M., 2019, “Human kinematic, kinetic and EMG data during different walking and stair ascending and descending tasks,” Scientific Data, 6, p. 309.
[21] Schiele, A., Letier, P., Der Linde, R. V., and Der Helm, F. V., 2006, “Bowden Cable Actuator for Force-Feedback Exoskeletons,” 2006 IEEE/RSJ International Conference on Intelligent Robots and Systems, pp. 3599-3604, doi: 10.1109/IROS.2006.281712.
[22] Song, Z. and Guo, S., 2012, “Design Process of Exoskeleton Rehabilitation Device and Implementation of Bilateral Upper Limb Motor Movement,” Journal of Medical and Biological Engineering, 32, pp. 323-330.

### D. Ankle-Foot Exoskeleton

### D1. BACKGROUND/Ankle-Foot Exoskeleton

### Introduction

Up to 80% of all stroke patients have some level of lower-limb muscular dystrophy and motor dysfunctionality [1]. Individuals experience severe weaknesses in ankle torque, load support, and plantarflexion/dorsiflexion muscular performance, resulting in extreme difficulties completing the simplest lower leg movements [2]. China, the country with the world's highest stroke rate and elderly population, has over 65 million individuals with lower motor disabilities [3]. About 400,000 people require external assistive personnel, but limited availability (approximately 1 for every 18 disabled individuals) has resulted in heavy development of rehabilitation robots and assistive mechanical devices [4].

Assistive exoskeletons act as an external replacement for impaired areas of patients, allowing them to perform everyday motor functions while wearing these devices [5]. Exoskeletons are typically worn by the users and support the body by mimicking the kinematics of the human limbs [6]. Traditional rigid exoskeletons were designed to make it easier for users to move with the system than without. While these devices provide high torque and structural body support, their static frames can limit the natural movement of the user and sometimes interfere if the alignment of joints between the body and exoskeleton is skewed [7]. High torque and structural support are compensated by large mass and bulky design, which can actually increase the required metabolic power required to utilize the exoskeleton, leading to fatigue and a reduction in performance quality [8], [9]. Prolonged usage of heavy devices can result in further injuries such as blisters and knee pain [10].

The soft exosuit balances portability and comfort with the same functionality as the larger assistive exoskeleton devices. Exosuits utilize flexible, lighter material for an overall lighter system that can contour to an individual's body shape more easily than a static exoskeleton [11], [12]. To maintain their small, portable status, cables are connected to anchor points on the user's lower limbs and are motorized by external actuators mounted on the user's body to simulate a pulling force on the plantarflexion and dorsiflexion muscles [13], [14]. One prototype utilized a bi-directional tendon-driven winch coupled with an actuator mounted on the ankle to minimize cable routing distance and cable friction [15]. The smaller, more compact actuation system required additional metabolic power due to its placement away from the body's natural center of mass, which can result in some limitations to the user's natural movement. To reduce any additional metabolic power and minimize movement restrictions, several prototype designs mounted the actuation units around the waist to position the heaviest components closest to the body's natural center of mass [16].

To personalize assistive devices and evaluate the recovery process of patients, plantar pressure measurement systems are used to measure foot-ground reaction forces, weight distribution, and gait cycles [17], [18]. During trials, force-sensitive resistors are mounted inside the footwear. The measured outputs are transmitted to an external computer for data analysis. The heel and metatarsal of the foot come in closest contact with the ground while standing, so many designs mount sensors specifically to measure the foot pressure in those areas [19]. The number of sensors varies based on the sensor's surface area and the desired accuracy of the measured data. An increase in the number of sensors often leads to additional retrievable data for a more reliable study, but requires additional calibration and design implementation; most prototype systems utilize anywhere from three to six pressure sensors for study [20].

In-shoe-based plantar pressure sensor systems are commonly used for orthotics studies due to the flexible nature of the system. The setup can be configured to fit a wide variety of different footwear and desired testing movements. However, a method of slipping prevention is necessary to secure the sensors in place to prevent them from shifting positions, resulting in unreliable data [21]. Methods of containing the sensors include sewing the sensors into fabric insoles, sealing them inside soft silicone, or directly attaching them to the foot sole with adhesives [22]. Studies vary between the use of wired and wireless sensors; while wireless sensors are much easier to implement, wired sensors provide more reliable data due to the direct connection made between the sensors and the computer [23]. Without a strong wireless connection, wireless sensors can prove to be more faulty despite their more modern, ergonomic design [24], [25].

In this study, a portable, lightweight, and cost-effective lower-limb ankle-brace pressure system is designed and fabricated for rehabilitation and movement purposes. The primary focus of the ankle brace was to utilize inexpensive materials to create an ergonomic design that could be modified to fit any individual's lower body shape. Small metallic joints and 3D-printed materials such as polylactic acid (PLA), polyethylene terephthalate glycol (PETG), and thermoplastic polyurethane (TPU) were used to reduce the overall weight of the brace. Foot pressure measurements are accomplished by a microcontroller providing signals to a series of force-sensitive resistors that measure the pressure of the foot sole. The system can be further modified to suit desired requirements such as more vigorous movement and a more dynamic brace with more degrees of freedom.

### D2. BRIEF DESCRIPTION OF THE DRAWINGS/Ankle-Foot Exoskeleton

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

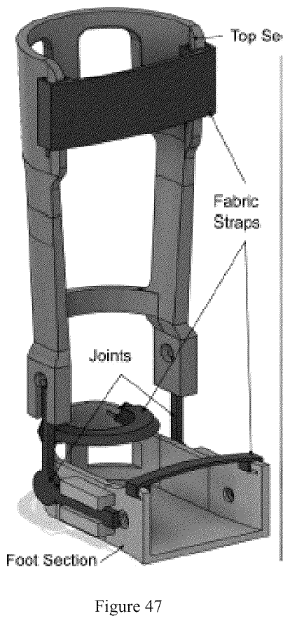

FIG. 47 is an illustrative drawing showing a perspective view of an ankle-foot exoskeleton in accordance with some embodiments.

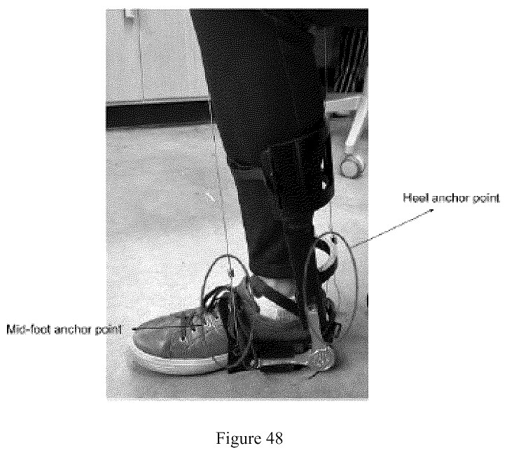

FIG. 48 is an illustrative drawing showing the example ankle-foot exoskeleton of FIG. 47 mounted to a user. The user is wearing a shoe.

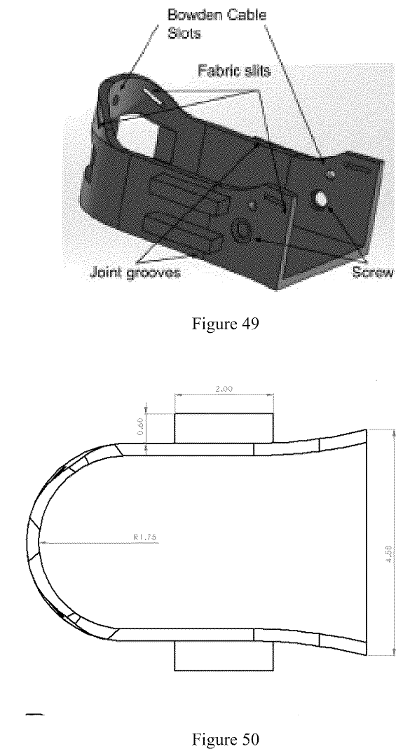

FIG. 49 is an illustrative perspective view of the example foot holder section of FIG. 47.

FIG. 50 is a top elevation view of the example foot holder section of FIG. 47.

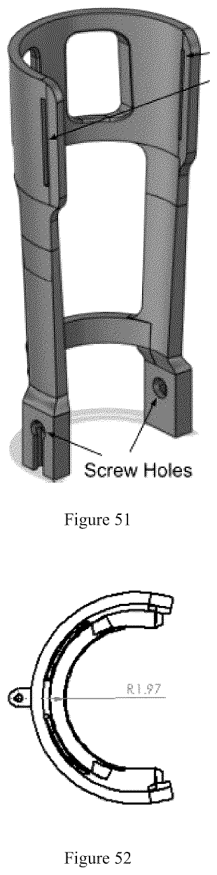

FIG. 51 is an illustrative perspective view of the example lower leg holder section of FIG. 47.

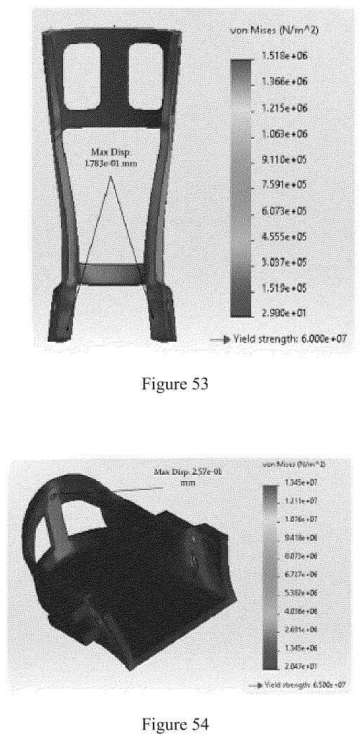

FIG. 52 is a top elevation view of the example lower leg holder section of FIG. 47.

FIG. 53 is an illustrative drawing of a lower leg holder section fabricated part and a corresponding stress-strain analysis for the fabricated part.

FIG. 54 is an illustrative drawing of a foot holder section fabricated part and a stress-strain analysis for the fabricated part.

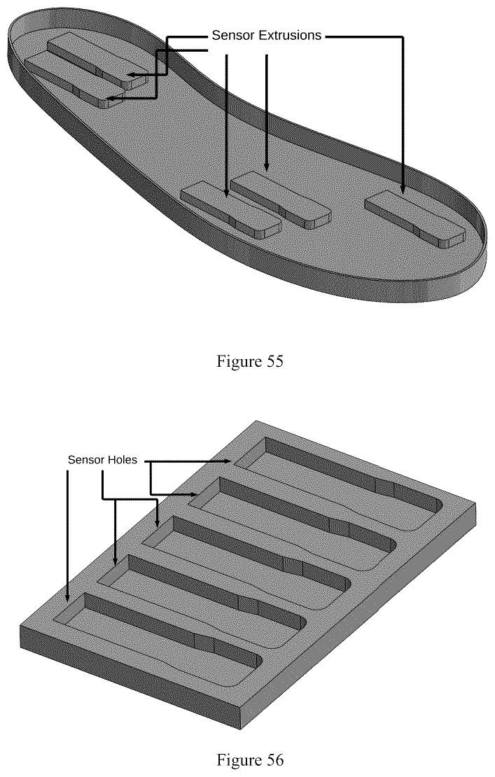

FIG. 55 is an illustrative drawing of a model in CAD software of a pressure insole casting mold.

FIG. 56 is an illustrative drawing of a model in CAD software of a sensor caps casting model.

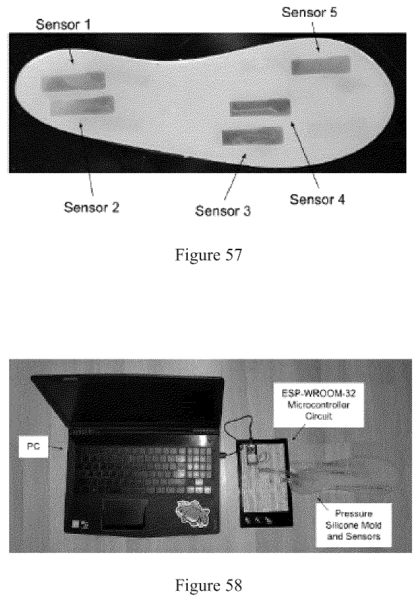

FIG. 57 is an illustrative drawing of a completed rubber insole with embedded pressure sensors.

FIG. 58 is an illustrative drawing that shows an example configuration of a pressure insole sensor system.

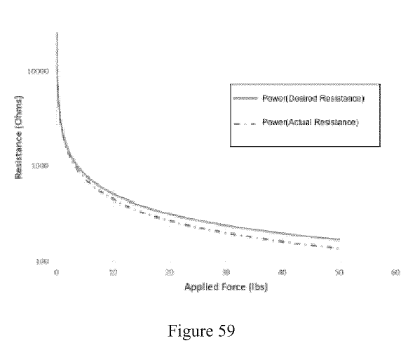

FIG. 59 is an illustrative curve showing force/resistance correlation up to 50 lbs as measured on the example pressure sensor system.

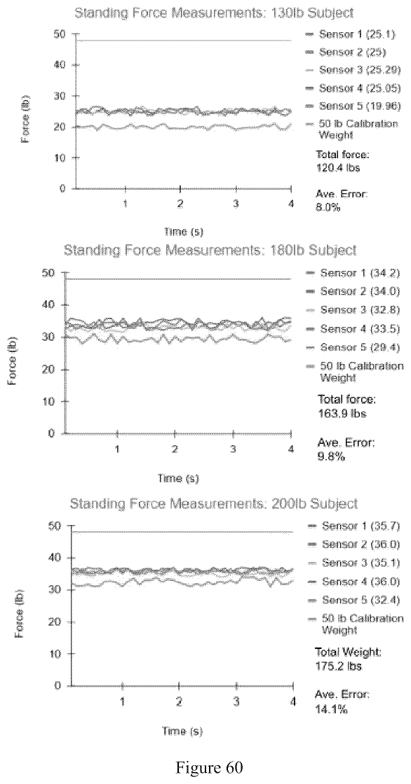

FIG. 60 shows illustrative graphs indicating force-sensitive resistor pressure readings during standing test trial for 180 and 200 lb test subjects.

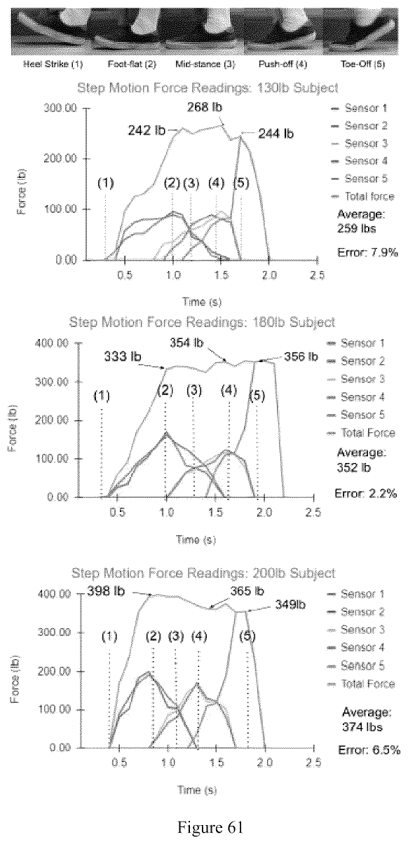

FIG. 61 shows illustrative graphs indicating gait cycle with labeled stance phase of the foot during a walking motion.

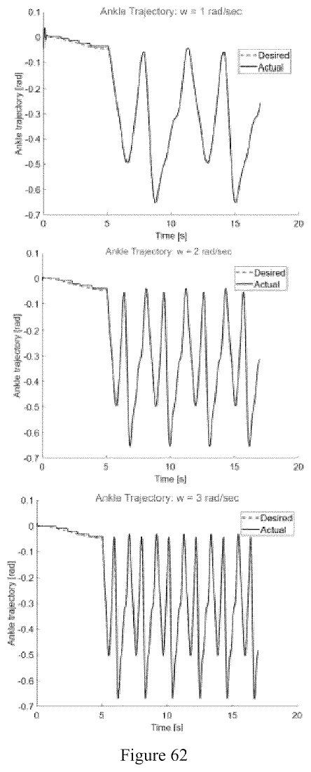

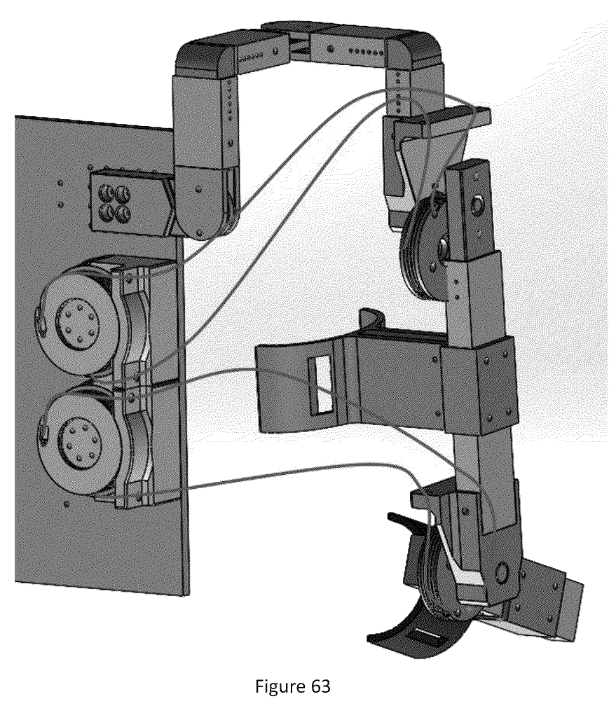

FIG. 62 shows illustrative graphs indicating ankle trajectory for walking motion at frequency rates of 1, 2, and 3 radians/second.

### D3. DETAILED DESCRIPTION/Ankle-Foot Exoskeleton

### Mechanical Overview of Foot-Ankle Exoskeleton

FIG. 47 is an illustrative drawing showing a perspective view of an ankle-foot exoskeleton in accordance with some embodiments. The example ankle-foot exoskeleton (hereinafter “AFE”) includes a foot holder section, a lower leg holder section, right-side and left-side hinges that secure the foot holder section to the lower leg holder section while permitting one-degree-of-freedom hinge motion that mimics the foot-ankle joint movement during walking, a front fabric foot strap extending across a front portion of the foot holder section, an ankle fabric foot strap extending across a middle portion of the foot holder section, and a front lower leg strap extending across a front portion of the lower leg holder section.

FIG. 48 is an illustrative drawing showing an example AFE mounted to a user. The user is wearing a shoe. The back portion of the shoe fits into the foot holder section. The lower leg holder section wraps around the back of the user's lower leg behind the ankle and the calf muscle. The front fabric foot strap and the ankle fabric foot strap hold the foot holder section to the shoe. The front lower leg strap holds the lower leg holder section against the calf muscle at the back of the leg. The right-side and left-side hinges (only one visible) that each includes a revolute joint that includes a revolute bearing coupled to a first link and to a second link that mechanically couple the foot holder section and the lower leg holder section to one another while permitting walking foot motion. A front-located Bowden cable is secured to a front portion of the foot holder section. A back-located Bowden cable is coupled to a back portion of the foot holder section. A first motor (not shown) is operably coupled to the front-located Bowden cable and a second motor (not shown) is operably coupled to a back-located Bowden cable. During a therapeutic event, the first and second motors can be controlled to impart forces upon the front-located and back-located motors that are coordinated to cause the foot holder section to mimic walking motion. The first motor and the second motor can be mounted on a lightweight base support structure (not shown) mounted on a user's back, for example.

FIG. 49 is an illustrative perspective view of the example foot holder section of FIG. 47. FIG. 50 is a top elevation view of the example foot holder section of FIG. 47. Referring to FIGS. 47-40, the foot holder section includes a flat bottom surface surrounded on three sides by upstanding walls and is open at the front. Inner and outer sidewalls upstand vertically from inner and outer sides of the flat bottom surface and a curved sidewall upstands from a back portion flat bottom surface shaped like the curved back portion of a shoe. The foot holder section has an inner contour that is shaped to conform to the shape of a back-half portion of a shoe. The bottom surface and the upstanding walls are dimensioned to receive and to at least partially abut against a rear portion of a shoe, with a user's foot inside, that is inserted into the foot holder section so as to hold the rear portion of the shoe while a front portion of the shoe extends beyond the foot holder section. More particularly, an example foot holder section extends from a heel portion of a shoe inserted therein where a user's heel would be located to a middle portion of the shoe approximately where the tarsals portion of a user's foot would be located. A front portion of the same shoe, starting approximately where the metatarsals and phalanges portions of a user's foot would be located, extends beyond the open front portion of the example foot holder section, and is located outside of and is not supported by the foot holder section.

A horizontal slot is formed in a raised front portion of each of the upstanding sidewalls to receive passage therethrough of the front fabric foot strap to extend over top of a middle section of a shoe inserted within the AFE. A slot is formed in each of opposite sides of a raised portion of the curved back portion of the sidewall to receive passage therethrough of the ankle fabric foot strap to extend across a user's ankle. A hole is formed in a front portion of each of the upstanding sidewalls to receive a front-located dorsiflexion Bowden cable. A hole is formed in a center region of the raised portion of the curved back portion of the sidewall to receive a back-located plantarflexion Bowden cable.

FIG. 51 is an illustrative perspective view of the example lower leg holder section of FIG. 47. FIG. 52 is a top elevation view of the example lower leg holder section of FIG. 47. Referring to FIG. 47, FIG. 48, FIG. 51, and FIG. 52, the lower leg holder section includes an elongated arch-shaped inner-side support rod, an elongated arch-shaped outer-side support rod, a thinner arch-shaped lower cross-connector bar connecting lower portions of the inner-side and outer-side support rods, a thicker arch-shaped upper cross-connector bar connecting upper portions of the inner-side and outer-side support rods. When the AFE is mounted to a user, the inner-side support rod is positioned closes to an inner portion of a user's lower leg and the outer-side support rod is positioned closes to an inner portion of a user's lower leg. When the AFE is mounted to a user, the thinner arch-shaped lower cross-connector bar is located closest to an Achilles heel portion of a user's leg and the thicker arch-shaped upper cross-connector bar is located closer to the user's calf muscle.

Referring to FIG. 47 and FIG. 49, a pair of parallel elongated horizontally extending ridges protrude from an outer facing portion of each of the sidewalls of the foot holder section. (Only one pair is visible.) Each pair of ridges defines a horizontal slot between them. A screw hole is formed in each sidewall forward of each slot. Referring to FIG. 47 and FIG. 51, a respective elongated longitudinally extending slot is formed in outer-facing bottom portions of the each of the inner-side support rod and the outer-side support rod. A respective screw hole is formed in an inner-facing portion of each of the inner-side support rod and the outer-side support rod at the top end portion of each slot.

A first link of each respective hinge extends within a respective horizontal slot and has an end portion closest to a front portion of the foot holder section secured with a screw that extends through a screw hole forward of the respective horizontal slot and has an end portion that is closest to a back portion of the foot holder section secured to a respective revolute bearing. A second link of each respective hinge extends within a respective longitudinal slot and has an end portion located within the longitudinal slot secured with a screw that extends through the screw hole formed at a top end portion of the respective longitudinal slot and has an end portion that is closest to a back portion of the foot holder section secured to a respective revolute bearing.

### Ankle Brace Design and Development

The design process of the prototype ankle brace is outlined in this section. Illustrated in FIG. 47, the ankle brace is composed of 2 fabricated components. The foot section is secured to the user's shoewear by flexible Velcro straps and connected to metallic revolute joints using screws. 2 holes just below the front fabric slits hold the dorsiflexion Bowden cable, while one hole at the rear of the foot section secures the plantarflexion Bowden cable. The remaining end of the revolute joint is connected to the calf section to create a one-degree-of-freedom hinge motion that mimics the foot-ankle joint movement during walking. The calf section has 2 notches that slide into holes on the half section to connect the 2 pieces together. The calf section is secured to the user's leg just below the knee joint using a large fabric strap. For the user's comfort, soft material will be lined in the inner portions of the top and calf sections.

Ankle Brace Structural Design, Finite Element Analysis, and 3D Printing. The design of the ankle brace was done with the purpose of providing sufficient supportive force during lower limb movement while being cost-effective and lightweight. Initial designs only included the calf section of the brace, but the foot section was added to create the hinge system. The foot section requires flexible material due to its contact with the ground, so thermoplastic polyurethane (TPU) was selected as the desired material. 2 fabric straps secure the section to the user's footwear at the ankle and the foot's midsection. The piece does not extend to the toe of the user to compensate for the available printing volume. The revolute joints are secured to the foot section via guide railings and screw holes on each side. The calf section secures the revolute joint in a similar manner using a joint-shaped hole and screws. Polylactic acid (PLA) and polyethylene terephthalate glycol (PETG) were used to print the calf section due to its structural design and purpose. The fabric straps and revolute joints are also included in FIG. 47; however, they are only cosmetic models used to represent how the accessories would connect to the brace.

FIGS. 2 and 3 show the CAD models and the 3D printed designs of the 2 fabricated components. The foot section was designed with a large shoe size in mind to fit the greatest possible range of foot sizes. The calf section is a 0.75-foot long piece that extends from the base of the knee down to the leg just above the ankle. Revolute hinge joints are then screwed into the bottom of the calf section and the foot piece. Due to the one-degree-of-freedom nature of the joint, the brace can only be used for simple walking or any motions that only involve the standard plantarflexion/dorsiflexion foot-ankle motion. Any additional degrees of freedom will require the separation of the upper and lower sections of the brace and removal of the metallic joints. With all the components together, the total weight of the ankle brace is around 2.5 pounds. The complete 3D brace can be seen in FIG. 48 with the fabricated 3D designed parts, metallic revolute joints, fabric strap, and 2 Bowden cables anchored to the foot piece.

Finite elemental analysis was conducted to ensure the proposed design of the foot piece was able to support the required loads with minimal deflection. During actuation, the Bowden cables initiate a vertical tugging motion on the foot section, lifting the front and heel sequentially to create the foot gait cycle. The foot section was subjected to a vertical force of 700N at the Bowden cable anchor holes. As shown in FIG. 53 and FIG. 54, the maximum stress of the foot section at the anchor points is 13.45 MPa with a maximum displacement value of 0.257 mm. The calf section was subjected to a 100N force applied at the joint connectors, yielding a maximum stress value of 1.486 MPa with a maximum displacement value of 0.1783 mm. The maximum stress values for both the calf and foot sections were well below the yield stress (60 MPa yield stress for TPU and PLA), indicating the design will not undergo any warping or fracture during trial testing and usage.

### Silicone-Based Pressure Sensor Mold.

The pressure silicone mold was fabricated by creating a model in CAD software of a pressure insole casting mold shown in FIG. 55 and creating a model in CAD software of a sensor caps casting model shown in FIG. 56. Designed to fit underneath a patient's foot, the shell was modeled after the shape of the foot. The design was split into two sections to accommodate the volume of the available 3D printers. Five sensor-shaped extrusions are placed in areas that experience the most pressure: the heel, midfoot, and toe. The holes are oriented so that the pins extend towards the heel, allowing the pins to be wired through the back of the mold for minimal interference with the ankle brace. The sensors are placed in these holes to prevent them from shifting during trials. To seal the sensors completely in the pressure silicone mold, another 3D design was created for the sensor hole caps, as shown in FIGS. 55-56. These designs were printed with PLA (these are simply casting molds, so no material was preferred for printing).

The base for the mold was the EcoFlex 00-30 silicone rubber, selected due to the adequate balance of softness and sturdiness, the relatively short curing time, and the high quantities available in stock with selected vendors. The silicone rubber came in two separate primer jars that, when mixed with equal quantities in a cup, were placed in a pressure pot to remove air pockets. The mixture was removed from the pressure pot, and the liquid was poured into the casting shells and left to rest until the silicone was completely cured. In FIG. 57, the main silicone rubber insole part is shown with the sensor configuration labeled. It is recommended that open footwear such as slippers and sandals be worn due to the multiple pinned sensors extending from the mold that require connection to a circuit.

### Pressure Sensor Mechatronics Development

This section covers the design of the pressure insole force-sensor system.

The electronic hardware for the system consists of resistors, capacitors, microcontroller, USB-A cable, PC, and force sensing resistors. The selected microcontroller model is the Ex-pressif ESP-WROOM-32 which comes with an 80 mA operating current and 240 MHz memory speed. The Flexiforce A201 sensor was used as the primary force-sensing resistor for its ultra-thin design and ability to quantify forces up to 1000 lb. With a total strip length of 7.5 inches and a 0.375-inch diameter sensing area, multiple sensors were able to be configured in the pressure insole system.

Each pressure sensor is connected in series with a resistor to create a voltage divider that outputs values that vary based on the resistor value and applied pressure. To prevent any potential fluctuations in the voltage readings, a capacitor is placed in parallel with the resistor. Each sensor is wired to the 5-voltage pin of the microcontroller, with the opposite pin wired to the ground pin. FIG. 58 shows the configuration of the pressure insole sensor system. The pressure sensors are inlaid in the silicone mold, and the pins are connected to the circuit board. The microcontroller is connected with a USB-A cable that provides communication with the PC and Arduino program.

### Sensor Calibration and Experimental Evaluation

To ensure the proper calibration of the pressure sensors, Eq. (1), the formula for a voltage divider, was used to determine the output of the force-sensitive resistor.

$${V}_{out} = ( \frac{{V}_{in} * R}{R + {R}_{fsr}} ) \qquad ( 1 )$$

Vᵢₙ, the voltage provided by the microcontroller pin, was set to a constant value of 5 volts, and the value of the resistor, R, was set to 10,000 Ohms. Vₒᵤₜ, the voltage of the force-sensitive resistor, determined the value of (R_{fsr}). For sensor calibration, the team applied various weights to the pressure sensors up to 50 lbs, recording the output value of the resistance of the force-sensitive resistor. FIG. 59 shows the force/resistance correlation comparison between the desired data (obtained from Flexiforce) and the measured data. It can be seen that as the applied force increases, the average error percentage for the resistance value increases, which can be attributed to several factors such as low input voltage, high resistor value, and the silicone mold. Based on the readings with the known weights, a best-fit curve was constructed to calculate the values of higher force readings based on the measured resistance values.

The performance of the sensor during the standing trial can be seen in FIG. 60 at a sampling rate of 100 ms. The standing pressure measurements were conducted with individuals that weighed approximately 130, 180, and 200 lbs. Each graph also contains the force value measured for a 50 lb weight to compare the measured force data with the data used for the calibration of the sensors. The individual force values obtained from each sensor were summed to obtain the total force across all five sensors, which was then compared to the test subject's actual weight. From the graphs, it can be seen that the average error values for the 130 lb, 180 lb, and 200 lb individuals are 8.0%, 9.8%, and 14.1% respectively. These values were calculated by comparing the total combined weight measured by the five sensors to the individual's actual weight. The increase in error can be attributed to the higher overall measured force values; as indicated from FIG. 59, the discrepancy between applied force and measured resistance increases as the applied weight is increased, so it is expected that at much higher applied force values, this error percentage will increase.

The motion of human walking is a gait cycle consisting of several phases. As shown in FIG. 61, the stance phase occurs when the foot is in contact with the ground. The five primary positions of the stance phase begin with the heel strike and end with the toe off, with the stance phase of the foot switching to the swing phase when the foot leaves contact with the ground. FIG. 12 also shows the measured force values for a foot stance phase for 130, 180, and 200 lb individuals, with the five positions of the stance phase marked on the graphs to match the motion of the foot with the corresponding measurements of the pressure sensors.

TABLE III
Ankle coefficients of the Fourier series while walking

| | | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|
| State | Joint | 0 | 1 | 2 | 3 | 4 | 5 | 6 | 1 | 2 | 3 | 4 | 5 | 6 |
| Walking | Ankle | 0.99 | [symbol] .29 | 8.58 | 0.48 | [symbol] .69 | 0.04 | [symbol] .30 | [symbol] .61 | 5.95 | [symbol] .92 | 2.12 | [symbol] .02 | 0.72 |

[symbol]

indicates data missing or illegible when filed

The desired total force values for the measured areas are typically two times the average body weight, which can be observed from the standing and stepping graphs. The increase in force is due to the individual exerting an additional force on the ground in order to propel our feet forward to complete a stepping motion [26]. The graphs all have three notable peaks that occur during the heel strike, mid-stance, and toe-off phases, as this is where most of the measured force was concentrated during those specific moments of the stance phase. The error values were determined by averaging the total measured force across all five sensors from the heel strike to the toe-off phase, then comparing the average total force to the theoretical measured values based on the individual's weight. Across the three tested individuals, the peak measured force value for each sensor during the walking tests was approximately two times the measured weight of the test subject, matching the expected desired outcomes for the expected measured force on the foot while walking.

### Motorized Ankle Trajectory Profiles

The ankle brace was also tested experimentally for walking motions using AK80-60 motors as the positional controller. FIG. 62 shows chart indicating ankle trajectory for walking motion at frequency rates of 1, 2, and 3 radians/second. The motor, capable of reaching a peak torque of 120 N/m, was connected to a circuit board that was powered by a 48V power supply. The circuit also used a CAN board to convert the C++ programming code into communication data that could be interpreted by the AK80-60 motors. The desired ankle trajectories were obtained from the Fourier series shown in Eq. (2) to generate the desired time-continuous profiles [27], [28].

$${q}_{des} ( t ) = {a}_{0} + {\sum }_{k = 1}^{N} [ {a}_{k} cos ( k {θ}_{i} ( t ) ) + {b}_{k} sin ( k {θ}_{i} ( t ) ) ] \qquad ( 2 )$$

The Fourier series coefficients can be identified by the variables aₖ and bₖ with N terms. Table III shows the values of the coefficients that correspond with the best-fit profile. FIG. 13 shows the ankle trajectory of the brace with the coefficients from Table III for frequency rates of 1, 2, and 3 radians per second respectively. The average error values across all 3 walking speeds were 2.8%, 3.6%, and 5.5%. The error increase can be attributed to increases in the maximum acceleration value at faster walking speeds.

### D4. REFERENCES/Ankle-Foot Exoskeleton

[1] Swaminathan, K., Park, S., Raza, F., Porciuncula, F., Lee, S., Nuckols, R. W., Awad, L. N., and Walsh, C. J., 2021, “Ankle resistance with a unilateral soft exosuit increases plantarflexor effort during pushoff in unimpaired individuals,” J. Neuroeng. Rehabil., 18(1), p. 182.
[2] Rao, S., Riskowski, J. L., and Hannan, M. T., 2012, “Musculoskeletal conditions of the foot and ankle: assessments and treatment options,” Best Pract. Res. Clin. Rheumatol., 26(3), pp. 345-368.
[3] GBD 2016 Lifetime Risk of Stroke Collaborators, 2018, “Global, regional, and country-specific lifetime risks of stroke, 1990 and 2016,” N. Engl. J. Med., 379(25), pp. 2429-2437.
[4] Shi, D., Zhang, W., Zhang, W., and Ding, X., 2019, “A review on lower limb rehabilitation exoskeleton robots,” Chin. J. Mech. Eng., 32(1).
[5] Lee, H., Ferguson, P. W., and Rosen, J., 2020, “Lower limb exoskeleton systems—overview,” Wearable Robotics, J. Rosen and P. W. Ferguson, eds., Elsevier, San Diego, CA, pp. 207-229.
[6] Kalita, B., Narayan, J., and Dwivedy, S. K., 2021, “Development of active lower limb robotic-based orthosis and exoskeleton devices: A systematic review,” Int. J. Soc. Robot., 13(4), pp. 775-793.
[7] Siviy, C., Baker, L. M., Quinlivan, B. T., Porciuncula, F., Swaminathan, K., Awad, L. N., and Walsh, C. J., 2023, “Opportunities and challenges in the development of exoskeletons for locomotor assistance,” Nat. Biomed. Eng., 7(4), pp. 456-472.
[8] Asbeck, A. T., Schmidt, K., Galiana, I., Wagner, D., and Walsh, C. J., 2015, “Multi-joint soft exosuit for gait assistance,” 2015 IEEE International Conference on Robotics and Automation (ICRA), IEEE, pp. 6197-6204.
[9] Oghogho, M., Sharifi, M., Vukadin, M., Chin, C., Mushahwar, V. K., and Tavakoli, M., 2022, “Deep reinforcement learning for EMG-based control of assistance level in upper-limb exoskeletons,” 2022 International Symposium on Medical Robotics (ISMR), IEEE, pp. 1-7.
[10] Panizzolo, F. A., Galiana, I., Asbeck, A. T., Siviy, C., Schmidt, K., Holt, K. G., and Walsh, C. J., 2016, “A biologically-inspired multi-joint soft exosuit that can reduce the energy cost of loaded walking,” J. Neuroeng. Rehabil., 13(1), p. 43.
[11] Porciuncula, F., Baker, T. C., Arumukhom Revi, D., Bae, J., Sloutsky, R., Ellis, T. D., Walsh, C. J., and Awad, L. N., 2021, “Targeting paretic propulsion and walking speed with a soft robotic exosuit: A consideration-of-concept trial,” Front. Neurorobot., 15, p. 689577.
[12] Sharifi, M., Mehr, J. K., Mushahwar, V. K., and Tavakoli, M., 2022, “Autonomous locomotion trajectory shaping and nonlinear control for lower limb exoskeletons,” IEEE ASME Trans. Mechatron., 27(2), pp. 645-655.
[13] In, H., Jeong, U., Lee, H., and Cho, K.-J., 2017, “A novel slack-enabling tendon drive that improves efficiency, size, and safety in soft wearable robots,” IEEE ASME Trans. Mechatron., 22(1), pp. 59-70.
[14] Sharifi, M., Mehr, J. K., Mushahwar, V. K., and Tavakoli, M., 2021, “Adaptive CPG-based gait planning with learning-based torque estimation and control for exoskeletons,” IEEE Robot. Autom. Lett., 6(4), pp. 8261-8268.
[15] Kwon, J., Park, J.-H., Ku, S., Jeong, Y., Paik, N.-J., and Park, Y.-L., 2019, “A soft wearable robotic ankle-foot-orthosis for post-stroke patients,” IEEE Robot. Autom. Lett., 4(3), pp. 2547-2552.
[16] Bae, J., Siviy, C., Rouleau, M., Menard, N., Odonnell, K., Geliana, I., Athanassiu, M., Ryan, D., Bibeau, C., Sloot, L., Kudzia, P., Ellis, T., Awad, L., and Walsh, C. J., 2018, “A lightweight and efficient portable soft exosuit for paretic ankle assistance in walking after stroke,” 2018 IEEE International Conference on Robotics and Automation (ICRA), IEEE, pp. 2820-2827.
[17] Aqueveque, P., Germany, E., Osorio, R., and Pastene, F., 2019, “Simple gait segmentation method using a novel plantar pressure measurement system with custom-made capacitive sensors: Preliminary results,” 2019 IEEE Global Humanitarian Technology Conference (GHTC), IEEE, pp. 1-4.
[18] Azimi, V., Nguyen, T. T., Sharifi, M., Fakoorian, S. A., and Simon, D., 2018, “Robust ground reaction force estimation and control of lower-limb prostheses: Theory and simulation,” IEEE Trans. Syst. Man Cybern. Syst., 50(8), pp. 1-12.
[19] Hu, J., Cao, H., Zhang, Y., and Zhang, Y., 2018, “Wearable plantar pressure detecting system based on FSR,” 2018 2nd IEEE Advanced Information Management, Communicates, Electronic and Automation Control Conference (IMCEC), IEEE, pp. 1687-1691.
[20] Pappas, I. P. I., Keller, T., Mangold, S., Popovic, M., Dietz, V., and Morari, M., 2004, “A reliable gyroscope-based gait-phase detection sensor embedded in a shoe insole,” IEEE Sens. J., 4(2), pp. 268-274.
[21] Razak, A. H. A., Zayegh, A., Begg, R. K., and Wahab, Y., 2012, “Foot plantar pressure measurement system: a review,” Sensors (Basel), 12(7), pp. 9884-9912.
[22] Park, J., Kim, M., Hong, I., Kim, T., Lee, E., Kim, E.-A., Ryu, J.-K., Jo, Y., Koo, J., Han, S., Koh, J.-S., and Kang, D., 2019, “Foot plantar pressure measurement system using highly sensitive crack-based sensor,” Sensors (Basel), 19(24).
[23] Crea, S., Donati, M., De Rossi, S. M. M., Oddo, C. M., and Vitiello, N., 2014, “A wireless flexible sensorized insole for gait analysis,” Sensors (Basel), 14(1), pp. 1073-1093.
[24] Wibowo, D. B., Suprihanto, A., Caesarendra, W., Khoeron, S., Glowacz, A., and Irfan, M., 2020, “A simple foot plantar pressure measurement platform system using force-sensing resistors,” Appl. Syst. Innov., 3(3), p. 33.
[25] Lim, D.-H., Kim, W.-S., Kim, H.-J., and Han, C.-S., 2017, “Development of real-time gait phase detection system for a lower extremity exoskeleton robot,” Int. J. Precis. Eng. Manuf., 18(5), pp. 681-687.
[26] Nilsson, J. and Thorstensson, A., 1989, “Ground reaction forces at different speeds of human walking and running,” Acta Physiol. Scand., 136(2), pp. 217-227.
[27] T. Lencioni, M. R. A. M., I. Carpinella and Ferrarin, M., 2019, “Humankinematic, kinetic and EMG data during different walking and stair ascending anddescending tasks,” Scientific data, 6(1).
[28] S. Nuzik, A. V., R. Lamb and Hirt, S., 1986, “Sit-to-Stand Movement Pattern: A Kinematic Study,” Physical Therapy, 66(11), p. 1708-1713.

### E. Upper Limb Exoskeleton for Shoulder and Elbow

### E1. BACKGROUND/Upper Limb, Shoulder, Elbow

### Introduction

Head trauma, strokes, and spinal cord injuries are the leading causes of sudden loss of mobility [1]. For purposes of rehabilitation, assistance, augmentation, and haptic devices, exoskeletons have been used for patients with such needs [2]. Using exoskeletons for these purposes has shown better outcomes for rehabilitation when compared to manual therapy [3]. While incredibly useful for rehabilitation, current exoskeleton designs have limitations. Current exoskeleton designs a heavy and bulky, making them difficult to carry for individuals suffering from injuries [4]. In addition, the bulk and complexity of these designs make operation difficult for users. For these reasons, studies show that individuals feel that while useful in a therapy setting, exoskeletons in their current form are not practical for daily use [5].

This study seeks to improve on existing upper-limb exoskeleton products within the market by reducing the overall weight and cost, as well as providing an adjustable design for all users and body types, all while maintaining a wide actuated range of motion. While exoskeletons on the market typically utilize multiple motors to actuate the assembly, this upper-limb exoskeleton utilizes only one motor per joint; for joints such as the shoulder, a full range of motion is achieved using a gimbal-style system of revolute joints, which can lock the mechanism into multiple positions about the joint. This reduction in the total actuators needed for motion leads to a decrease in the overall weight and complexity of the exoskeleton.

This exoskeleton is controlled in a mirror therapy scenario by tracking the movements of the user's opposite arm. The control software (C++) communicates with the DC motors (AK80-9) and triple-axis accelerometer gyroscope sensors (MPU6050) via an ESP32 microcontroller. The control software generates the user's intended movement for the exoskeleton, which is determined based on the movement and orientation of the user's opposite arm measured by MPU6050 sensors. The desired movement trajectories for the shoulder and elbow joints will be followed by DC motors. Multiple manufacturing methods have been utilized and the majority of the components for this exoskeleton have been fabricated from PETG using Fusion Deposition Modeling (FDM) 3D printing. In order to accommodate various body types and sizes, each link of this wearable device can be adjusted in length. Each segment consists of an outer aluminum beam and a PETG inner link, with threaded hex bolts to secure the desired overall length. This allows for a lightweight and structurally adaptable design that can deliver high amounts of torque required to drive the upper arm and forearm of the wearer by the developed exoskeleton. Experimental studies have been performed on various point-to-point reaching tasks within the entire reach space of the arm, which showed high accuracy and smoothness in tracking the desired joint trajectories.

### E2. BRIEF DESCRIPTION OF THE DRAWINGS/Upper Limb, Shoulder, Elbow

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 63 is an illustrative perspective view of an example upper limb exoskeleton for shoulder and elbow in accordance with some embodiments.

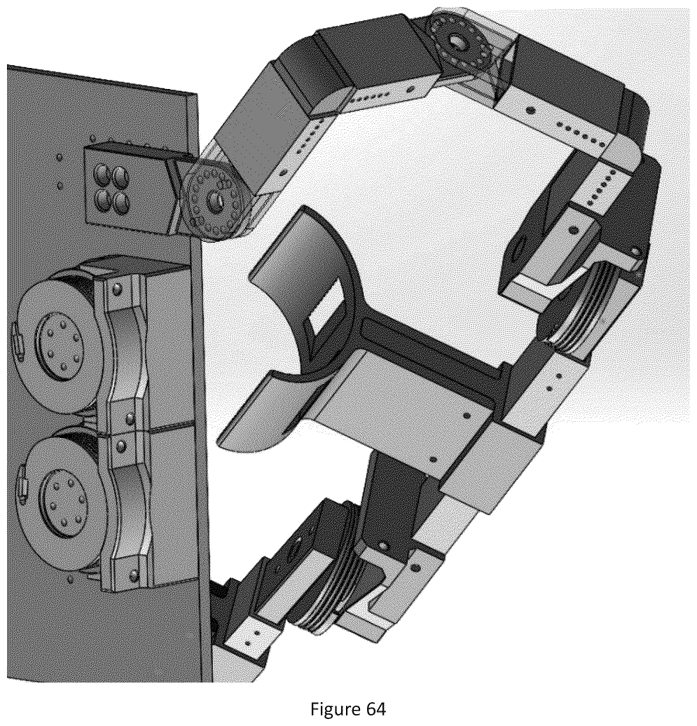

FIG. 64 an illustrative perspective view of the example upper limb exoskeleton of FIG. 1 with the gimbal assembly configured in an example second static gimbal position.

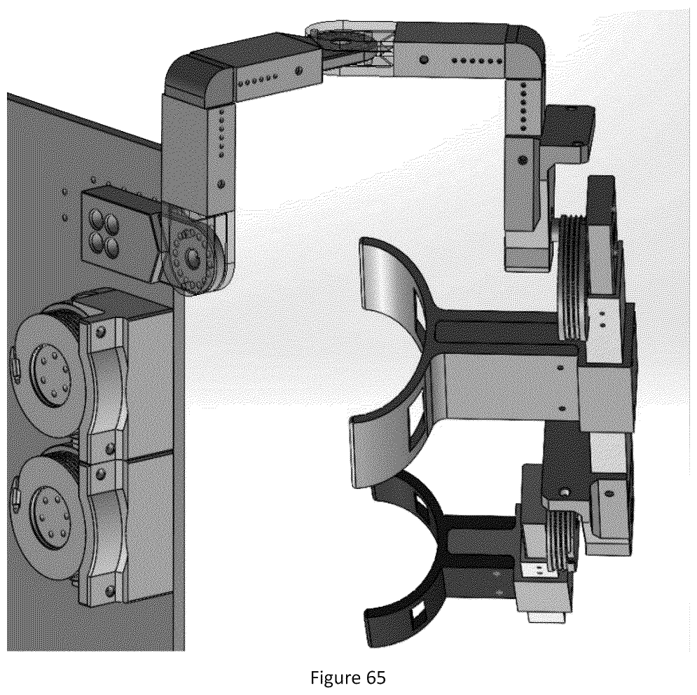

FIG. 65 an illustrative perspective view of the example upper limb exoskeleton of FIG. 1 with the gimbal assembly configured in an example third static gimbal position.

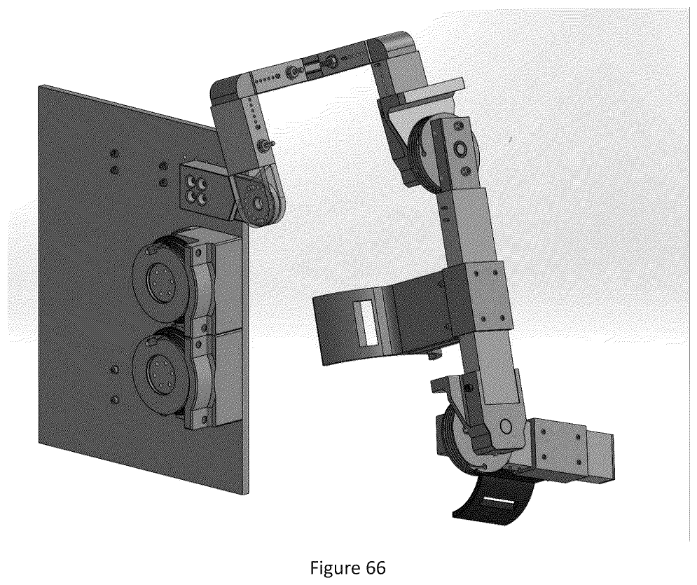

FIG. 66 an illustrative perspective view of the example upper limb exoskeleton of FIG. 1 with the static gimbal assembly configured in an example fourth gimbal position.

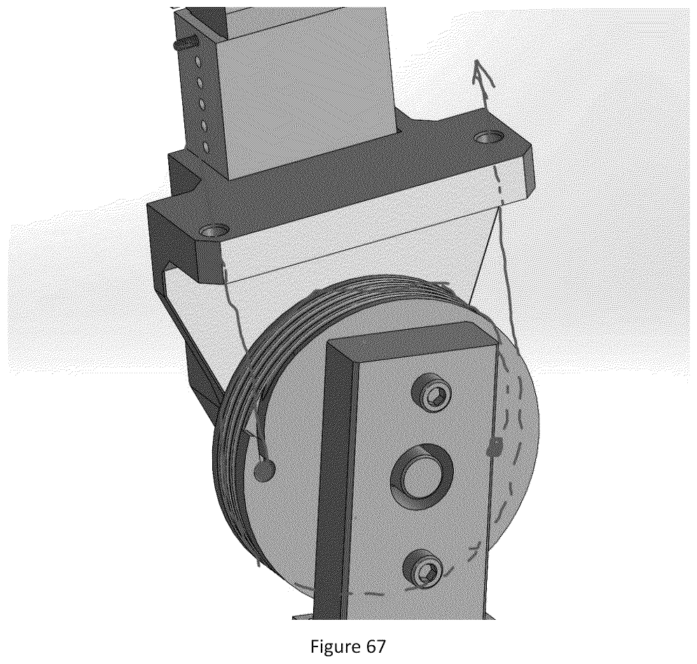

FIG. 67 is an illustrative perspective drawing showing certain details of a first pulley. In accordance with some embodiments.

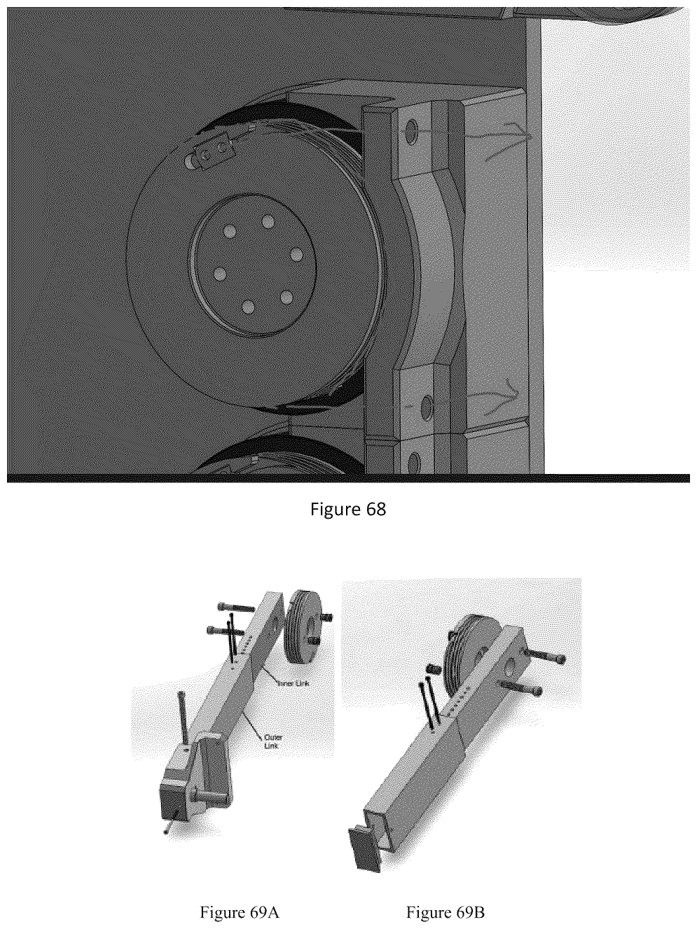

FIG. 68 is an illustrative perspective drawing showing certain details of a first motor mounted to the base support structure in accordance with some embodiments.

FIG. 69A is an illustrative drawing showing a CAD model perspective view of an example telescopable adjustable length upper arm section CAD model.

FIG. 69B is an illustrative drawing showing a CAD model perspective view of an example telescopable adjustable length forearm section CAD model.

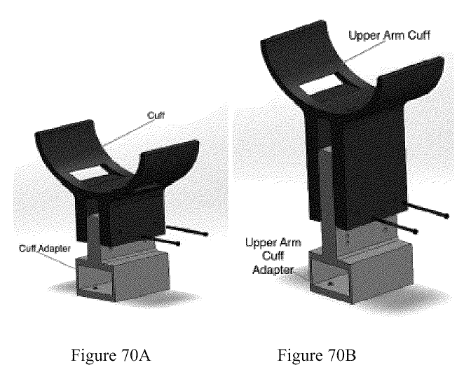

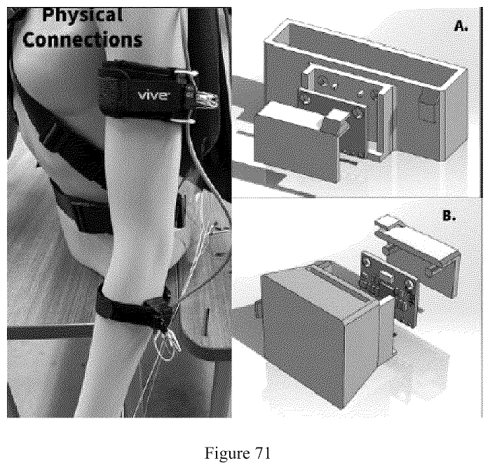

FIG. 70A is an illustrative drawing showing an example upper arm cuff and corresponding cuff adapter.

FIG. 70B is an illustrative drawing showing an example forearm cuff and corresponding cuff adapter.

FIG. 71 is an illustrative drawing showing a gyro-accelerometer unit secured to a user's arm and showing exploded views of the unit.

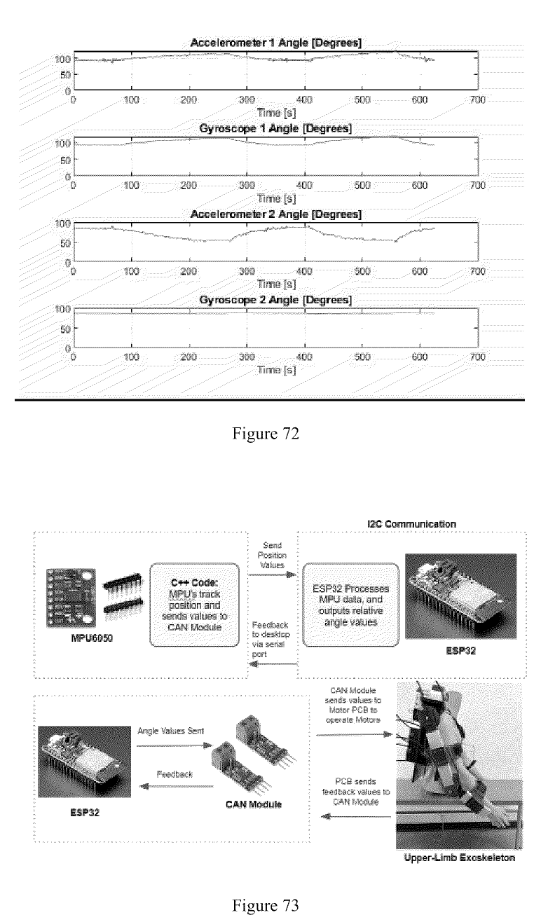

FIG. 72 is an illustrative drawing showing gyroscope and accelerometer readings from the gyro-accelerometer unit of FIG. 71.

FIG. 73 is an illustrative drawings representing an example ESP setup for CAN module and backplate MPU.

### E3. DETAILED DESCRIPTION/Upper Limb, Shoulder, Elbow

### Mechanical Overview of Upper Limb Exoskeleton for Shoulder and Elbow

FIG. 63 is an illustrative perspective view of an example upper limb exoskeleton for shoulder and elbow in accordance with some embodiments. The example upper limb exoskeleton (hereinafter “ULE”) includes a base support structure configured to rest upon the back portion of a patient, a gimbal assembly mounted to the base support structure, and an arm assembly mounted to the gimbal assembly. The gimbal assembly includes a first linkage section and a second linkage section that are rotatably coupled to respective first and second revolute joints that have respective first and second axes of rotation that are perpendicular to one another. A manual force can be used to rotationally move the first and second linkage sections about the respective first and second axes to position the arm assembly at a desired static position and orientation relative to the base support structure. The arm assembly includes an upper arm section and a forearm section, which can be mounted to a patient's arm. The upper arm section and the forearm section are rotatably coupled to respective first and second pulleys that have respective third and fourth axes of rotation that are parallel to one another and perpendicular to each of the first and second axes of rotation. A first motor mounted to the base support structure is operably coupled to impart rotational motion to the upper arm section about the third axis. A second motor mounted to the base support structure is operably coupled to impart rotational motion to the forearm arm section about the fourth axis. The first and second linkage sections can be locked in the desired static position during motor-impelled motion of the upper arm and the lower arm.

Healthy upper arm shoulder motion involves three degrees of freedom. The ULE imitates the human upper arm's three degrees of shoulder motion freedom through motion of the first linkage section about the first axis, motion of the second linkage section about the second axis, and motion of the upper arm about the third axis, since the first, second, and third axes are perpendicular to one another. The first linkage section, which is mounted to the base support structure and the second linkage section, which is mounted to the first linkage section, are configured such that when the ULE is mounted on a patient, the first pulley can be positioned adjacent to the patient's shoulder, and the second pulley can be positioned adjacent to the patient's elbow. As explained more fully below, adjustments to the lengths of the various components that make up the ULE may be required to achieve this adjacency. During a therapeutic session with the upper arm section and the forearm section mounted to a patient's arm, the first and second linkage sections of the gimbal assembly can be rotationally moved to a desired static position to fix position of a patient's upper arm section and the forearm section in two degrees of freedom. Then, for therapeutical purposes, the first motor can be used to impart upper arm shoulder rotational motion in the third degree of freedom about the third axis while the second motor can be used to impart rotational motion about the third axis to the forearm.

The illustrative drawing of FIG. 63 shows the ULE with the gimbal assembly configured in an example first static gimbal position. As used herein, the term “proximal” refers to locations closer to the patient's upper torso and the term “distal” refers to locations farther from the patient's upper torso. FIG. 64 an illustrative perspective view of the example ULE of FIG. 63 with the gimbal assembly configured in an example second static gimbal position. FIG. 65 an illustrative perspective view of the example ULE of FIG. 63 with the gimbal assembly configured in an example third static gimbal position. FIG. 66 an illustrative perspective view of the example ULE of FIG. 63 with the static gimbal assembly configured in an example fourth gimbal position. Movement of the upper arm section and the forearm section of the arm assembly and corresponding movement of a patient's upper arm and forearm mounted thereupon are determined by the static gimbal position. More particularly, each different static gimbal position retrains movement of the upper arm section and the forearm section of the arm assembly and corresponding movement of a patient's upper arm to a corresponding different plane of motion.

Referring to FIGS. 63-66, the first linkage section includes a first linkage element that includes a proximal end portion and a distal end portion and includes a second linkage element that includes a proximal end portion and a distal end portion. An example first linkage element includes a first elongated rectangular bar, and an example second linkage element includes a second elongated rectangular bar. The second linkage section includes a third linkage element that includes a proximal end portion and a distal end portion and includes a fourth linkage element that includes a proximal end portion and a distal end portion. An example third linkage element includes a third elongated rectangular bar, and an example fourth linkage element includes a fourth elongated rectangular bar. The upper arm section includes a proximal end portion and a distal end portion. The forearm section includes a proximal end portion and a distal end portion. An example upper arm section includes a rectangular bar, and an example forearm section includes a rectangular bar.

The proximal end portion of the first linkage element defines a first clevis. A fixture secures a first rotatable bearing to the base support structure such that the first rotatable bearing is suspended beyond a side edge of the base support structure. In the example ULE, the first rotatable bearing is suspended beyond a right-side edge of the base support structure. The first rotatable bearing is rotatable about the first axis, which is perpendicular to a plane of the base support structure. The first rotatable bearing is fixedly secured between arms of the first clevis such that the first clevis and the first rotatable bearing form the first revolute joint such that the first link is rotatable about the first axis in a plane parallel to a plane of the base support structure. The fixture includes stop surfaces that are angled and positioned to limit rotation of the first linkage element about the first axis such that the second linkage element cannot be rotated to a position in which it contacts the base support structure.

The proximal end portion of the second link element is fixedly secured to the distal end portion of the first link element and extends in a cantilever fashion from the distal end of the first link element in a forward direction parallel to the first axis of rotation and perpendicular to the second axis of rotation. A second rotatable bearing that is rotatable about the second axis of rotation is suspended from the distal end portion of the second link. The proximal end portion of the third link element defines a second clevis. The second rotatable bearing is fixedly secured between arms of the second clevis such that the second clevis and the second rotatable bearing form the second revolute joint such that the third link element is rotatable about the second axis of rotation in a plane that is perpendicular to a plane of the base support structure.

The proximal end portion of the fourth link element is fixedly secured to the distal end portion of the third link element and extends in a cantilever fashion from the distal end of the third link element in a direction perpendicular to the first axis of rotation and parallel to the second axis of rotation. The proximal end portion of the upper arm section is rotatably secured to the distal end portion of the fourth link element. More particularly, the first pulley is located between the distal end portion of the fourth link element and the proximal end portion of the upper arm section. The first pulley is mounted for rotation about an axle bearing that extends outward toward the upper arm section from the distal end portion of the fourth link element. The first pulley is fixedly secured to the proximal end portion of the upper arm section such that rotation of the first pulley about the third axis of rotation causes corresponding rotation of the upper arm section about the third axis of rotation. In an example ULE, the first pulley is fixedly secured to a side of the distal end portion of the fourth link element that faces generally away from the base support structure.

The proximal end portion of the forearm section is rotatably secured to the distal end portion of the upper arm section. More specifically, the second pulley is located between the distal end portion of the upper arm section and the proximal end portion of the forearm section. The second pulley is mounted for rotation about an axle bearing that extends outward toward the upper arm section from the distal end portion of the upper arm section. The second pulley is fixedly secured to the proximal end portion of the forearm section such that rotation of the second pulley about the fourth axis of rotation causes corresponding rotation of the forearm section about the fourth axis of rotation. In an example ULE, the second pulley is fixedly secured to a side of the distal end portion of the upper arm section that faces generally toward the base support structure.

An upper arm brace extends from a side of the upper arm section that faces generally toward the base support structure to receive a patient's upper arm. A first pedestal secures the upper arm brace to the upper arm section. A forearm brace extends from a side of the forearm section that faces generally toward the base support structure to receive a patient's forearm. A second pedestal secures the forearm brace to the forearm section.

Referring to FIG. 63, an example ULE includes a first and second Bowden cable segments configured to transmit torque force between the first motor and the first pulley to impart rotational motion of the upper arm section about the third axis rotation. Still referring to FIG. 63, the example ULE includes a third and fourth Bowden cable segments to transmit torque force from the second motor to the second pulley to impart rotational motion of the forearm section about the fourth axis rotation. Bowden cables are not shown in FIGS. 64-66 to simplify the drawings for clarity of understanding of interaction of other components of the ULE.

FIG. 67 is an illustrative perspective drawing showing details of the first pulley rotatably mounted to the distal end portion of the fourth link element and fixedly secured to the proximal end portion of the upper arm section. Referring to FIG. 63 and FIG. 67, first and second Bowden cable segments include respective first end portions secured to the first pulley and arranged such that a first force imparted by the first motor to the first Bowden cable segment causes rotation of the first pulley and the upper arm section coupled thereto in a one rotational direction about the third axis of rotation. A second force imparted by the first motor to the second Bowden cable segment causes rotation of the first pulley and the upper arm section coupled thereto in an opposite rotational direction about the third axis of rotation. A flange extending outward from the distal end portion of the fourth link element defines first and second guide holes to align the first and second Bowden cable segments with the first pulley.

FIG. 68 is an illustrative perspective drawing showing details of first motor mounted to the base support structure. In an example ULE, the first and second motors are motor pulleys. Referring to FIG. 63 and FIG. 68, the first motor is operatively coupled to a first motor pulley such that actuation of the first motor imparts rotation to the first motor pulley. Respective second end portions of the first and second Bowden cable segments are secured to the first motor pulley and arranged such that actuation of the first motor that causes the first motor pulley to rotate in one direction and to impart the first force to the first Bowden cable segment and actuation of the first motor that causes the first motor pulley to rotate in an opposite rotational direction and to impart the second force to the second Bowden cable segment. A flange extending outward from the base support structure defines third and fourth guide holes to align the first and second Bowden cable segments with the first motor pulley. Arrangement and operation of third and fourth Bowden cable segments, and the second motor, and the second pulley are like those of the first and second Bowden cable segments, the first motor, and the first pulley, will be readily understood from the above description and in the interest of economy of disclosure, will not be explained herein in detail.

### Mechanical Design

The exoskeleton is composed of three main structures. The main linkage assembly is composed of the adjustable forearm and upper arm links, which are connected to the pulleys and pulley housing to provide movement. Cuffs are used to mount the linkage to the user's forearm and upper arm. The back plate assembly is composed of a carbon fiber base plate on which the motors and motor housings are mounted to. These motors power pulleys, which are connected through Bowden cables to corresponding pulleys located on the arm linkage at the shoulder and elbow. Connected to the base plate is a heat-formed HDPE plate that is shaped to the user's back. The gimbal assembly connects the arm linkage and the back plate and is positioned over the user's shoulder. This mechanism allows the user access to the full range of motion, despite only one degree of freedom being powered.

Links (Upper-arm and Forearm) and Cuffs The upper arm section and forearm section, as shown in FIGS. 69A-69B, includes an internal and external component. The internal part of the upper arm section and forearm section are machined out of 6061 Aluminum rectangle tubing and the inner parts of the upper arm and forearm links are printed out of PETG. These materials were chosen to ensure the mechanism was lightweight while still maintaining high overall strength. Dimensions for these components were chosen based on the strength properties of these materials. The two arm sections are collapsable or extendable to provide adjustability and accommodate individuals of varying arm proportions. The internal upper-arm link was designed to allow for about 4 inches of adjustability and the internal forearm section allows for about 1.5 inches of adjustability. As length adjustments should only need to be calibrated once to suit the user, two bolts were used in order to most effectively fix the desired adjusted length by the user. By using these two bolts, the links are tightly secured together without any risks of shifting or flexing.

For attachment of the exoskeleton to the user's body, adjustable and flexible cuffs, as shown in FIG. 70A-70B, were designed. The upper arm cuff defines a slot and is mounted to a cuff adaptor that includes a groove that can be inserted to different depth into the slot and secured with a pin to adjust the distance the upper arm cuff extends outward from the upper arm. Similarly, the forearm cuff defines a slot and is mounted to a cuff adaptor that includes a groove that can be inserted to different depth into the slot and secured with a pin to adjust the distance the forearm cuff extends outward from the upper arm. The cuffs were printed out of TPU to ensure flexibility, again to accommodate different arm sizes. These cuffs were designed around an adapter component, which slid right over and attached the cuffs to the upper arm and forearm links. The cuff adapter was printed out of PETG to provide a strong, rigid structure for mounting. Screw holes were made on the adapter so that the cuff adapter could be securely bolted onto the links at the desired position, and on the cuff to secure the actual cuff to the adapter. Much like the upper arm and forearm links, this series of screw holes allow for the cuff's distance to be adjusted from the arm link as needed to properly mesh with the user's arm. Padded Nylon straps were used in order to comfortably secure the user's arm inside the cuff.

Pulleys and Cable Mounts The pulleys (in FIGS. 4 and 5) are one of the key parts of the design, being used to allow the displaced motors to actuate each joint. A pulley is placed at the elbow and shoulder joint (FIGS. 63-66), attaching to the forearm and upper arm links respectively, these pulleys are also secured directly on the AK80-9 motors on the backplate of the exoskeleton. They serve as the exoskeleton's power delivery system, using Bowden cables to transfer torque from the AK80-9 motors mounted on the backplate to each joint independently. The pulleys were designed to securely nest the ends of the Bowden cables, as well as provide grooves for the length of the cable to nest into.

The pulley is connected to the upper arm and forearm links by the cable mounts and a static shaft (FIGS. 63-66). This cable mount component is utilized on the primary arm assembly, as well as the backplate of the exoskeleton, which also serves as the mount for the AK80-9 Motor and the pulley attached to it. This cable mount is used to provide connection points for the Bowden cable outer tubes and feed the cables directly from the motor pulley to the actuated pulley. Both of these components were fabricated out of PETG using FDM 3D printing for the material's high strength, as these components will be experiencing a high amount of stress from the actuated bowden cables.

Shoulder Gimbal The gimbal-style shoulder aspect of the design serves to allow the repositioning of the shoulder joint along the transverse and frontal planes, where the actuated joint acts along the sagittal plane. There are two joints, the shoulder, and elbow, that allow the human arm to move in a full range of motion. As this design utilizes a single motor for each of the joints, a solution was needed in order to maintain a full range of motion for three degrees of freedom joints such as the shoulder. To achieve this, research was done into the remote center-of-motion joints that would allow the user to change the position of the single actuated axis of rotation about the transverse and frontal planes. With the user being able to move this axis to each of the three planes of motion, the full range of motion is maintained. For the purposes of this exoskeleton, a gimbal-style mechanism was chosen. The gimbal mechanism utilizes two extra revolute joints to provide for repositioning about the shoulder joint.

By designing a gimbal mechanism that would orbit the pulley housing around a joint (FIGS. 63-66), the user could position the powered rotational axis in any desired orientation. A locking pin would also be implemented that would allow the user to lock the angle of the gimbal links, fixing the shoulder pulley's position about the user's shoulder joint. The gimbal mechanism developed for this exoskeleton positions the two revolute joints in the top and rear positions. In addition, the length of each link within the shoulder mechanism can be adjusted to fit different-sized users. This was accomplished by designing the gimbal links to be collapsible similar to the upper arm and forearm links, and are locked in place using bolts. The inner component of the gimbal link was printed out of PETG for its high-strength properties, and the outer section of the gimbal link was machined out of Aluminum tubing to increase strength and reduce weight.

Backplate The backplate, shown in FIGS. 63-66, serves as a mounting system for the upper limb exoskeleton and the high-torque motors. It is also what allows the user to comfortably wear the exoskeleton. The backplate is composed of two parts. First, there is the high-density polyethylene sheet, which was heat formed to conform to the user's back. This makes the exoskeleton more ergonomic and comfortable for the operator to wear. The second component of the backplate consists of a rigid, flat plate fabricated out of carbon fiber and epoxy resin, which mounts to the back of the high-density polyethylene sheet. This component is what was used to mount the upper arm exoskeleton and the high-torque motors. It was manufactured by alternating four layers of carbon fiber sheets with epoxy resin, placing a foam core sheet in the center, and adding four more alternating layers of carbon fiber sheets and epoxy resin. After the epoxy resin was cured, clearance holes for bolts were drilled in order to secure the arm assembly, motors, and cable mounts.

### Micro-Controller and Electronic System Interface

The control system for the exoskeleton consists of three gyro-accelerometers, an ESP32 microcontroller, a CAN module, and two DC motors. The idea is to track the orientation of either the user's opposing arm or potentially a physician's arm movement. To do this, the mechanism will be using three gyro-accelerometers in tandem to track the position of the upper and lower arm. The gyro-accelerometer board this group will be using is the MPU-6050. This board has both the accelerometer and gyroscope makes it optimal for this design because the signal from both sensors can be combined to fit the design's needs in terms of response time and lasting accuracy. The gyroscope will give the system the sensitivity it needs with the ability to track movements of up to ±2000°/sec. There is a drawback to using this sensor and that is it has a continual drift, so it becomes increasingly inaccurate as data is continuously collected. That is where the accelerometer comes into play being able to smooth out the signal from the gyro using a complementary filter. Another important feature that comes with this sensor is there is lots of documentation of interfacing it using many different combinations of code editors, microcontrollers, and coding languages. The MPU 6050 operates using I2C communication, this allows us to configure multiple devices on a single bus. However, the ESP32 default settings only include one I2C bus, but by using the “Wire.h” library we are able to configure any of the controllers GPIO pins to be I2C compatible. This is a necessary feature because the MPU 6050 only has two unique addresses, 0x68 and 0x69. So, there can only be two of these devices on a bus at one time. So, another I2C bus is used to communicate with the other board [6].

The outputs from the board are processed using the “Adafruit Sensor.h” and “Adafruit MPU6050.h” libraries. Using these allows for easy access to rotational velocity from the gyro and acceleration values from the accelerometer. Position can be tracked using the gyroscope by using a discrete-time integrator, simply put we multiply the rotational velocity reading by the time it takes our code to make one loop, effectively allowing us to get angle change values. Then, with the accelerometer, we are able to track angle changes using components of the acceleration reading. The components used are dependent on the orientation of the board. Both of the position tracking methods have their own drawbacks, so to get the most accurate data possible we add the two values together in a complimentary filter [7].

Once position values are able to be read we use a MPU 6050 shown in FIG. 71 that is mounted to the backplate of the exoskeleton as a reference for the other sensors tracking the position of the arm. This way the device will be able to differentiate between an arm raise and the user bending at the waist. Additionally, the MPU mounted to the forearm, shown FIG. 82, is referencing the position of the MPU on the humerus, shown in FIG. 82. This is to prevent any potential hazards from misalignment or out-of-the-ordinary sensor readings, from hyper-extending the user's arm. The data received from these gyro-accelerometers attached to the upper arm and forearm are illustrated in FIG. 83.

Additionally, the microcontroller that was chosen was the ESP32 FIG. 84. This board has several advantages including the ability to connect to WiFi for remote communication. There is also lots of documentation around interfacing the MPU-6050 Gyro-Accelerometer board with the ESP32 which will make for easy implementation and interfacing. Specifically, this group will be using Visual Studio Code, and Platform-IO IDE to develop code and store it on the board. There are also libraries available that process the signals from MPU-6050 into usable data. This group will use this to determine the position of the board and the motion of the user's arm, which will then be used in a feedback control loop to maintain symmetric arm motion.

The actuator that will be used to drive the exoskeleton is the AK80-9. This is a precise smooth motor that will provide 9 Nm of torque to the exoskeleton. Because the device is cable driven the diameter of the pulleys used at the joints will affect the actual force the exoskeleton is capable of putting out. It is desirable for safety reasons that the motor will stall before the links of the exoskeleton. This motor does introduce another level of complexity to our design; however, because it requires CAN communication protocol. This calls for the use of a CAN module to interface with the microcontroller

Another benefit of the chosen actuator is that it comes with a detailed user manual that illustrates the communication protocol for operating it in many different modes. So, the expectation of the electromechanical system is that it will continually try to maintain symmetric motion between the arm with accelerometers and the arm in the exoskeleton. Ideally, the device should be able to precisely track arm movements at low speeds but some lag is expected with faster movements.

### E4. REFERENCES/Upper Limb, Shoulder, Elbow

[1] T. Prasanna, L. F., 2022. “Esp32 i2c communication: Set pins, multiple bus interfaces and peripherals (arduino ide)”. National Library Of Medicine, June.
[2] T. Plessis, K. Djouani, C. O., 2021. “A review of active hand exoskeletons for rehabilitation and assistance”. MDPI Open Access Journals, March.
[3] G. Chen, C. K. Chan, Z. G. H. Y., 2013. “A review of lower extremity assistive robotic exoskeletons in rehabilitation therapy”. Begell House Digital Library.
[4] Gorgey, A., 2018. “Robotic exoskeletons: The current pros and cons”. World Journal of Orthopedics, September.
[5] Dominique Kinnett-Hopkins, Chaithanya K. Mummidisetty, L. E.-J. D. C. R. A. B. M. H. A. A. J. C. F. G. F. E. F.-F . . . . A. W. H., 2020. “Users with spinal cord injury experience of robotic locomotor exoskeletons: a qualitative study of the benefits, limitations, and recommendations”. Journal of NeuroEngineering and Rehabilitation, September.
[6] Santos, S., 2019. “Esp32 i2c communication: Set pins, multiple bus interfaces and peripherals (arduino ide)”. RANDOM NERD TUTORIALS, October.
[7] Dejan, 2020. “Arduino and mpu6050 accelerometer and gyroscope tutorial”. HOW TO MECHATRONICS, September.

The above description is presented to enable any person skilled in the art to create and use an exoskeleton. Various modifications to the embodiments will be readily apparent to those skilled in the art, and the generic principles defined herein may be applied to other embodiments and applications without departing from the spirit and scope of the invention. In the preceding description, numerous details are set forth for the purpose of explanation. However, one of ordinary skill in the art will realize that the embodiments in the disclosure might be practiced without the use of these specific details. In other instances, well-known processes are shown in block diagram form in order not to obscure the description of the invention with unnecessary detail. Identical reference numerals may be used to represent different views of the same or similar item in different drawings. Thus, the foregoing description and drawings of examples in accordance with the present invention are merely illustrative of the principles of the invention. Therefore, it will be understood that various modifications can be made to the embodiments by those skilled in the art without departing from the spirit and scope of the invention, which is defined in the appended claims.

1. A human-wearable exoskeleton comprising:
a base;
an articulable mechanical member configured to be secured to a portion of the human anatomy having a joint;
a pulley motor secured to the base;
a Bowden cable secured to the pulley motor and the articulable mechanical member; and
wherein the mechanical member is configured to articulate in response to the pulley motor imparting force to the Bowden cable.
